(19) United States
(12) Patent Application Publication
(10) Pub. No.: US 2026/0031702 A1
(43) Pub. Date: Jan. 29, 2026

(54) RESONANT CONVERTER

(71) Applicant: LITE-ON Technology Corporation, Taipei (TW)

(72) Inventors: Bo-Ruei CIOU, Taipei (TW); Chen CHEN, Taipei (TW)

(21) Appl. No.: 19/243,004

(22) Filed: Jun. 19, 2025

Related U.S. Application Data
(60) Provisional application No. 63/675,744, filed on Jul. 26, 2024.

(30) Foreign Application Priority Data
Jan. 22, 2025 (CN) 2025100979566

(51) Int. Cl. H02M 1/00; H01F 27/24; H02M 3/00; H02M 3/335

(52) U.S. Cl. CPC H02M 1/0058; H01F 27/24; H02M 3/01; H02M 3/33573; H02M 3/33592

(57) ABSTRACT

A resonant converter includes an input circuit, a first switch circuit, a resonant circuit, a voltage regulation circuit, a second switch circuit, and an output circuit. The first switch circuit is coupled to the input circuit and includes first switch units. The resonant circuit includes resonant tanks, each resonant tank includes a resonant capacitor and a resonant inductor which are coupled in series, and the resonant inductors are coupled to the output nodes of the first switch units by wye connection. The resonant capacitors are coupled to the primary side of the voltage regulation circuit by the wye connection. The second switch circuit includes second switch units and is coupled to the second switch circuit, and the input nodes of the second switch units are coupled to the secondary side of the voltage regulation circuit by delta connection. By the aforementioned arrangement, ZVS or ZCS is implemented.

### CROSS-REFERENCE TO RELATED APPLICATIONS

This application claims the priority benefit of Provisional Patent Application Ser.

No. 63/675,744 filed on Jul. 26, 2024 and Chinese Patent Application Serial Number 2025100979566 filed on Jan. 22, 2025, the full disclosure of which is incorporated herein by reference.

### TECHNICAL FIELD OF THE INVENTION

The present disclosure relates to the technical field of power converters and particularly relates to a resonant converter.

### DESCRIPTION OF THE PRIOR ART

As environmental consciousness extends, an electric vehicle (EV) starts to rise and develops rapidly to replace a car and a diesel vehicle. Because the needed electrical energy of the EV is higher, a high power converter is often required to assist the electrical energy distribution of the EV.

Generally, the current high power converter applied to the EV is a full bridge converter.

Although the full bridge converter provides stable high output power, the switching of switch components in the full bridge converter is hard switching, and the hard switching results in the switching loss of the switch components, thereby increasing the power loss of the full bridge converter and diminishing the power conversion efficiency (PCE) of the full bridge converter.

### SUMMARY

In light of the aforementioned descriptions, the present disclosure provides a resonant converter to solve the problem of the high power loss of the power converter.

Based on the aforementioned descriptions, the present disclosure provides the resonant converter. The resonant converter includes an input circuit, a first switch circuit, a resonant circuit, a voltage regulation circuit, a second switch circuit, and an output circuit. The input circuit provides an input voltage. The first switch circuit is coupled to the input circuit and includes a plurality of first switch units, and each first switch unit includes an output node. The resonant circuit includes a plurality of resonant tanks, and each resonant tank includes a resonant capacitor and a resonant inductor which are coupled in series. The resonant inductors are coupled to the output nodes by wye connection. There are a plurality of connection nodes between the primary side of the voltage regulation circuit and the resonant capacitors, and the resonant capacitors are coupled to the primary side of the voltage regulation circuit by the wye connection based on the connection nodes. The second switch circuit includes a plurality of second switch units, and each second switch unit includes an input node. The input nodes are coupled to the secondary side of the voltage regulation circuit by delta connection. The output circuit is coupled to the second switch circuit and generates an output voltage.

In view of the above description, the resonant converter of the present disclosure fulfills zero voltage switching (ZVS) or zero current switching (ZCS) by the arrangement of the resonant circuit, thereby reducing the switching loss of the switch components and the power loss of the power converter.

The aforementioned description of the present disclosure is merely the outline of the technical solutions of the present disclosure. In order to understand the technical solutions of the present disclosure clearly and to implement the present disclosure according to the content of the specification, the better embodiments of the present disclosure given herein below with accompanying drawings are used to describe the present disclosure in detail.

### BRIEF DESCRIPTION OF DRAWINGS

FIG. 1A depicts the circuit diagram of a resonant converter according to one embodiment of the present disclosure.

FIG. 1B depicts the block diagram of a first switch circuit and a controller according to one embodiment of the present disclosure.

FIG. 1C depicts the timing diagrams of the control signals of the first switch circuit according to one embodiment of the present disclosure.

FIG. 1D depicts the block diagram of a second switch circuit and the controller according to one embodiment of the present disclosure.

FIG. 1E depicts the timing diagrams of the control signals of the second switch circuit according to one embodiment of the present disclosure.

FIG. 1F depicts the timing diagrams of an input current, a resonant current, a magnetizing current, and a second current according to one embodiment of the present disclosure.

FIG. 1G depicts the timing diagrams of the control signals of a first high-side switch and a first high-side rectifying switch according to one embodiment of the present disclosure.

FIG. 2 depicts the circuit diagram of a half bridge-half bridge resonant converter.

FIG. 3 depicts the circuit diagram of a full bridge-full bridge resonant converter.

FIG. 4 depicts the error comparison diagrams of the resonant current of the resonant converter and the resonant current of the full bridge-full bridge resonant converter according to one embodiment of the present disclosure.

FIG. 5A depicts the 3D diagram of magnetic cores according to one embodiment of the present disclosure.

FIG. 5B depicts the cross section diagram of magnetic cores according to one embodiment of the present disclosure.

FIG. 6A depicts the 3D diagram of magnetic cores according to another embodiment of the present disclosure.

FIG. 6B depicts the cross section diagram of magnetic cores according to another embodiment of the present disclosure.

FIG. 7A depicts the 3D diagram of magnetic cores according to a yet embodiment of the present disclosure.

FIG. 7B depicts the cross section diagram of magnetic cores according to a yet embodiment of the present disclosure.

FIG. 8A depicts the 3D diagram of magnetic cores according to a still embodiment of the present disclosure.

FIG. 8B depicts the cross section diagram of magnetic cores according to a still embodiment of the present disclosure.

FIG. 9A depicts the 3D diagram of magnetic cores according to yet another embodiment of the present disclosure.

FIG. 9B depicts the cross section diagram of magnetic cores according to yet another embodiment of the present disclosure.

FIG. 10A depicts the 3D diagram of magnetic cores according to still another embodiment of the present disclosure.

FIG. 10B depicts the cross section diagram of magnetic cores according to still another embodiment of the present disclosure.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely one part of the embodiments of the present disclosure and not all embodiments of the present disclosure. Based on the embodiments of the present disclosure, all embodiments obtained by a person skilled in the art without any inventive steps shall fall within the scope of protection of the present disclosure.

It should be noted that the terms “first”, “second”, etc. in the specification and claims of the present disclosure and in the accompanying drawings are used to distinguish similar objects and not used to describe a particular order or sequence. Furthermore, the terms “comprising” and “having”, and any variation thereof, are intended to encompass a non-exclusive inclusion, for example, a series of steps or units comprising processes, methods, systems, products or equipment do not need to be limited to those steps or units clearly listed but may include other steps or units not clearly listed or inherent to those processes, methods, products or equipment.

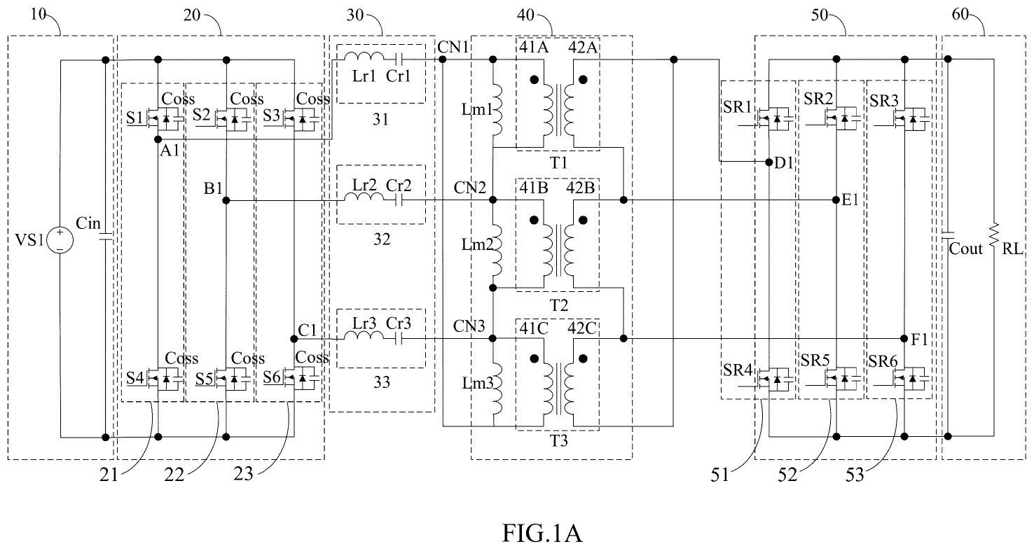

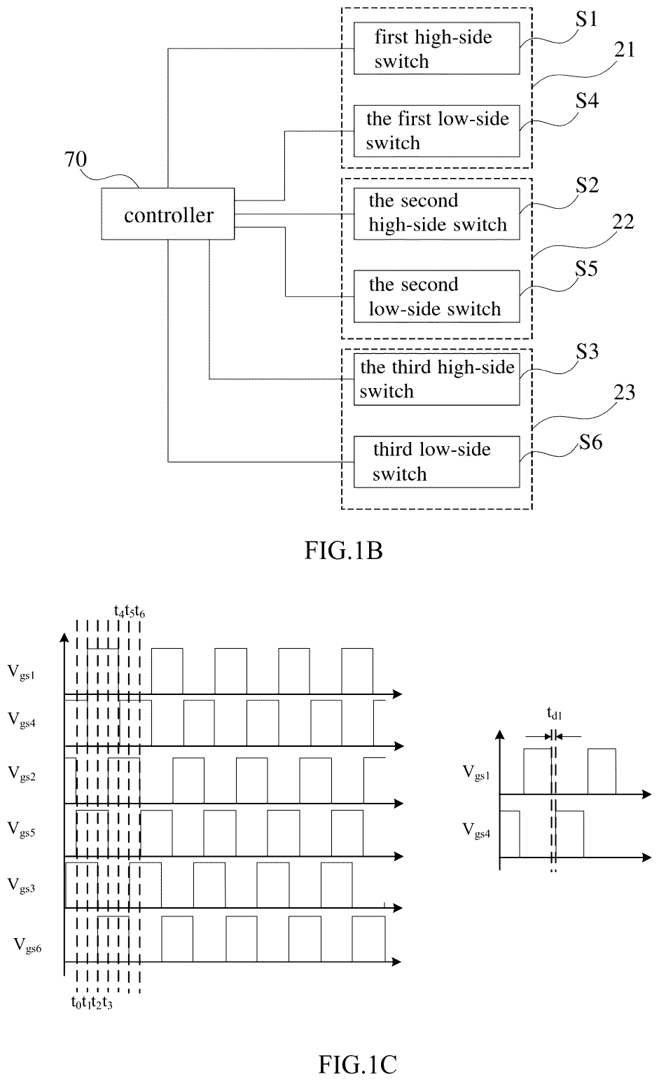

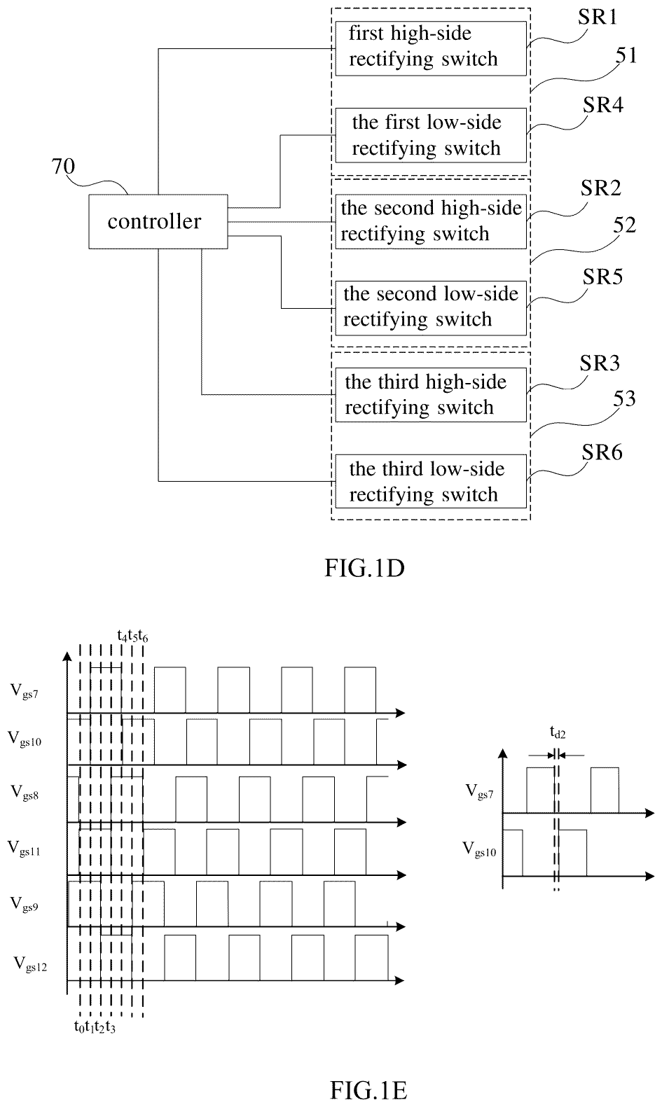

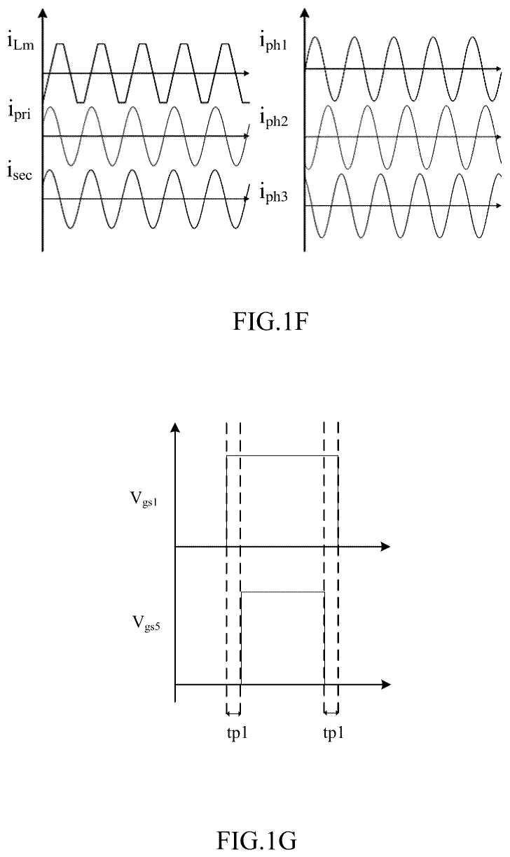

Please refer to FIG. 1A, which depicts the circuit diagram of a resonant converter according to one embodiment of the present disclosure. As shown in FIG. 1A, the resonant converter includes an input circuit 10, a first switch circuit 20, a resonant circuit 30, a voltage regulation circuit 40, a second switch circuit 50, and an output circuit 60.

The input circuit 10 includes a voltage source VS1 and an input capacitor Cin. The voltage source VS1 provides an input voltage. Two terminals of the input capacitor Cin are separately coupled to the voltage source VS1, i.e., the input capacitor Cin is coupled to the voltage source VS1 in parallel.

The first switch circuit 20 is coupled to the input circuit 10 and includes first switch units 21, 22 and 23. The first switch units 21, 22 and 23 are coupled to one another in parallel. The first switch unit 21 includes a first high-side switch S1, a first low-side switch S4, and a first output node A1; the first high-side switch S1 is coupled to one terminal of the input capacitor Cin, the first low-side switch S4 is coupled to the other terminal of the input capacitor Cin, the first high-side switch S1 and the first low-side switch S4 are coupled in series, and the first output node A1 is disposed between the first high-side switch S1 and the first low-side switch S4. The first switch unit 22 includes a second high-side switch S2, a second low-side switch S5, and a second output node B1; the second high-side switch S2 is coupled to the first high-side switch S1, the second low-side switch S5 is coupled to the first low-side switch S4, the second high-side switch S2 and the second low-side switch S5 are coupled in series, and the second output node B1 is disposed between the second high-side switch S2 and the second low-side switch S5. The first switch unit 23 includes a third high-side switch S3, a third low-side switch S6, and a third output node C1; the third high-side switch S3 is coupled to the second high-side switch S2, the third low-side switch S6 is coupled to the second low-side switch S5, the third high-side switch S3 and the third low-side switch S6 are coupled in series, and the third output node C1 is disposed between the third high-side switch S3 and the third low-side switch S6.

The resonant circuit 30 includes a plurality of resonant tank, and each resonant tank includes a resonant capacitor and a resonant inductor which are coupled in series. The resonant inductors are coupled to the output nodes by wye connection. Specifically, the resonant circuit 30 includes a first resonant tank 31, a second resonant tank 32, and a third resonant tank 33. The first resonant tank 31 includes a first resonant inductor Lr1 and a first resonant capacitor Cr1 which are coupled in series. One terminal of the first resonant inductor Lr1 is coupled to the first output node A1, while the other terminal of the first resonant inductor Lr1 is coupled to the first resonant capacitor Cr1. The second resonant tank 32 includes a second resonant inductor Lr2 and a second resonant capacitor Cr2 which are coupled in series. One terminal of the second resonant inductor Lr2 is coupled to the second output node B1, while the other terminal of the second resonant inductor Lr2 is coupled to the second resonant capacitor Cr2. The third resonant tank 33 includes a third resonant inductor Lr3 and a third resonant capacitor Cr3 which are coupled in series. One terminal of the third resonant inductor Lr3 is coupled to the third output node C1, while the other terminal of the third resonant inductor Lr3 is coupled to the third resonant capacitor Cr3. The first resonant inductor Lr1, the second resonant inductor Lr2 and the third resonant inductor Lr3 are coupled to the first output node A1, the second output node B1, and the third output node C1 by the wye connection. In comparison with an arrangement in which the first resonant inductor Lr1, the second resonant inductor Lr2, and the third resonant inductor Lr3 are coupled to the first output node A1, the second output node B1, and the third output node C1 by delta connection, the arrangement in which the first resonant inductor Lr1, the second resonant inductor Lr2, and the third resonant inductor Lr3 are coupled to the first output node A1, the second output node B1, and the third output node C1 by the wye connection may decrease the values of the resonant inductors to one-third of the original values thereof.

Because of the serial coupling of the first resonant inductor Lr1 and the first resonant capacitor Cr1, the serial coupling of the second resonant inductor Lr2 and the second resonant capacitor Cr2, and the serial coupling of the third resonant inductor Lr3 and the third resonant capacitor Cr3, the first resonant frequency of the first resonant tank 31, the second resonant frequency of the second resonant tank 32, and the third resonant frequency of the third resonant tank 33 may be represented by fᵣ₁₌₁/(2π(Lr1Cr1)^{1/2}), fᵣ₂=1/(2π(Lr2Cr2)^{1/2}), and fᵣ₃=1/(2π(Lr3Cr3)^{1/2}), and fᵣ₁, fᵣ₂, and fᵣ₃ are the first resonant frequency of the first resonant tank 31, the second resonant frequency of the second resonant tank 32, and the third resonant frequency of the third resonant tank 33 respectively. By adjusting the values of the first resonant inductor Lr1 and the first resonant capacitor Cr1, the values of the second resonant inductor Lr2 and the second resonant capacitor Cr2, and the values of the third resonant inductor Lr3 and the third resonant capacitor Cr3, the first resonant frequency fᵣ₁ of the first resonant tank 31, the second resonant frequency fᵣ₂ of the second resonant tank 32, and the third resonant frequency fᵣ₃ of the third resonant tank 33 are determined.

When the switching frequency of the first switch unit 21 is greater than the first resonant frequency fᵣ₁, the first resonant tank 31 exhibits an inductive characteristic and is provided with a ZVS characteristic; when the switching frequency of the first switch unit 21 is less than the first resonant frequency fᵣ₁, the first resonant tank 31 exhibits a capacitive characteristic and is provided with a ZCS characteristic. When the switching frequency of the first switch unit 22 is greater than the second resonant frequency fᵣ₂, the second resonant tank 32 exhibits the inductive characteristic and is provided with the ZVS characteristic; when the switching frequency of the first switch unit 22 is less than the second resonant frequency fᵣ₂, the second resonant tank 32 exhibits the capacitive characteristic and is provided with the ZCS characteristic. When the switching frequency of the first switch unit 23 is greater than the third resonant frequency fᵣ₃, the third resonant tank 33 exhibits the inductive characteristic and is provided with the ZVS characteristic; when the switching frequency of the first switch unit 23 is less than the third resonant frequency fᵣ₃, the third resonant tank 33 exhibits the capacitive characteristic and is provided with the ZCS characteristic. By adjusting the switching frequency of the first switch unit 21 to the switching frequency of the first switch unit 23, the ZVS characteristics and the ZCS characteristics of the first resonant tank 31 to the third resonant tank 33 are adjusted.

There are a plurality of connection nodes between the primary side of the voltage regulation circuit 40 and the resonant capacitors, and the resonant capacitors are coupled to the primary side of the voltage regulation circuit 40 by the wye connection based on the connection nodes.

Specifically, the voltage regulation circuit 40 includes a first transformer T1, a second transformer T2, and a third transformer T3. There is a first connection node CN1 between the primary side of the first transformer T1 and the first resonant capacitor Cr1, and the first connection node CN1 is coupled to the primary side of the third transformer T3. There is a second connection node CN2 between the primary side of the second transformer T2 and the second resonant capacitor Cr2, and the second connection node CN2 is coupled to the primary side of the first transformer T1. There is a third connection node CN3 between the primary side of the third transformer T3 and the third resonant capacitor Cr3, and the third connection node CN3 is coupled to the primary side of the second transformer T2. The first resonant capacitor Cr1 is coupled to the primary side of the voltage regulation circuit 40 by the wye connection based on the first connection node CN1, the second resonant capacitor Cr2 is coupled to the primary side of the voltage regulation circuit 40 by the wye connection based on the second connection node CN2, and the third resonant capacitor Cr3 is coupled to the primary side of the voltage regulation circuit 40 by the wye connection based on the third connection node CN3. In comparison with an arrangement in which the first resonant capacitor Cr1, the second resonant capacitor Cr2, and the third resonant capacitor Cr3 are separately coupled to the primary side of the voltage regulation circuit 40 by the delta connection, the arrangement in which the first resonant capacitor Cr1, the second resonant capacitor Cr2, and the third resonant capacitor Cr3 are separately coupled to the primary side of the voltage regulation circuit 40 by the wye connection would increase the values of the resonant capacitors to three times the original values thereof.

The first transformer T1 includes a primary side coil winding set 41A, a magnetizing inductor Lm1, and a secondary side coil winding set 42A. The primary side coil winding set 41A is disposed on the primary side of the first transformer T1, is coupled to the magnetizing inductor Lm1 in parallel, and is coupled to the first resonant capacitor Cr1 by the first connection node CN1. The secondary side coil winding set 42A is disposed on the secondary side of the first transformer T1. The second transformer T2 includes a primary side coil winding set 41B, a magnetizing inductor Lm2, and a secondary side coil winding set 42B. The primary side coil winding set 41B is disposed on the primary side of the second transformer T2, is coupled to the magnetizing inductor Lm2 in parallel, and is coupled to the second resonant capacitor Cr2 by the second connection node CN2. The secondary side coil winding set 42B is disposed on the secondary side of the second transformer T2. The third transformer T3 includes a primary side coil winding set 41C, a magnetizing inductor Lm3, and a secondary side coil winding set 42C. The primary side coil winding set 41C is disposed on the primary side of the third transformer T3, is coupled to the magnetizing inductor Lm3 in parallel, and is coupled to the third resonant capacitor Cr3 by the third connection node CN3. The secondary side coil winding set 42C is disposed on the secondary side of the third transformer T3.

The primary side coil winding set 41A of the first transformer T1, the primary side coil winding set 41B of the second transformer T2, and the primary side coil winding set 41C of the third transformer T3 are coupled to one another by the delta connection; in other words, the primary side of the first transformer T1, the primary side of the second transformer T2, and the primary side of the third transformer T3 are coupled to one another by the delta connection.

Similarly, the secondary side coil winding set 42A of the first transformer T1, the secondary side coil winding set 42B of the second transformer T2, and the secondary side coil winding set 42C of the third transformer T3 are coupled to one another by the delta connection; in other words, the secondary side of the first transformer T1, the secondary side of the second transformer T2, and the secondary side of the third transformer T3 are coupled to one another by the delta connection. By the aforementioned arrangement, the current values of the primary side coils and the secondary side coils of the first transformer T1 to the third transformer T3 may be reduced, thus reducing the copper loss of the coils.

The second switch circuit 50 includes second switch units 51, 52 and 53. The second switch units 51, 52 and 53 are coupled to one another in parallel. The second switch unit 51 includes a first high-side rectifying switch SR1, a first low-side rectifying switch SR4, and a first input node D1; the first high-side rectifying switch SR1 and the first low-side rectifying switch SR4 are coupled in series, and the first input node D1 is disposed between the first high-side rectifying switch SR1 and the first low-side rectifying switch SR4 and is coupled to the secondary side coil winding set 42A. The second switch unit 52 includes a second high-side rectifying switch SR2, a second low-side rectifying switch SR5, and a second input node E1; the second high-side rectifying switch SR2 and the second low-side rectifying switch SR5 are coupled in series, the second high-side rectifying switch SR2 is coupled to the first high-side rectifying switch SR1, the second low-side rectifying switch SR5 is coupled to the first low-side rectifying switch SR4, and the second input node E1 is disposed between the second high-side rectifying switch SR2 and the second low-side rectifying switch SR5 and is coupled to the secondary side coil winding set 42A and the secondary side coil winding set 42B. The second switch unit 53 includes a third high-side rectifying switch SR3, a third low-side rectifying switch SR6, and a third input node F1; the third high-side rectifying switch SR3 and the third low-side rectifying switch SR6 are coupled in series, one terminal of the third high-side rectifying switch SR3 is coupled to the second high-side rectifying switch SR2, one terminal of the third low-side rectifying switch SR6 is coupled to the second low-side rectifying switch SR5, and the third input node F1 is disposed between the third high-side rectifying switch SR3 and the third low-side rectifying switch SR6 and is coupled to the secondary side coil winding set 42B and the secondary side coil winding set 42C. The first input node D1, the second input node E1, and the third input node F1 are coupled to the secondary side of the first transformer T1, the secondary side of the second transformer T2, and the secondary side of the third transformer T3 by the delta connection.

The first high-side switch S1, the first low-side switch S4, the second high-side switch S2, the second low-side switch S5, the third high-side switch S3, the third low-side switch S6, the first high-side rectifying switch SR1, the first low-side rectifying switch SR4, the second high-side rectifying switch SR2, the second low-side rectifying switch SR5, the third high-side rectifying switch SR3, and the third low-side rectifying switch SR6 may be metal-oxide-semiconductor field-effect transistors (MOSFETs), trench MOSFETs or insulated gate bipolar transistors (IGBTs), and the foregoing descriptions are merely exemplary and are not used to limit the present disclosure.

The output circuit 60 is coupled to the second switch circuit 50. Specifically, the output circuit 60 includes an output capacitor Cout and a load resistance RL which are coupled to each other in parallel; one terminal of the output capacitor Cout is coupled to the third high-side rectifying switch SR3 and one terminal of the load resistance RL, while the other terminal of the output capacitor Cout is coupled to the third low-side rectifying switch SR6 and the other terminal of the load resistance RL. In other words, the output capacitor Cout and the second switch unit 53 are coupled in parallel.

Please refer to FIG. 1B, which depicts the block diagram of the first switch circuit and a controller according to one embodiment of the present disclosure. As shown in FIG. 1B, the resonant converter further includes the controller 70. The controller 70 is coupled to the first high-side switch S1, the first low-side switch S4, the second high-side switch S2, the second low-side switch S5, the third high-side switch S3, and the third low-side switch S6 to generate and transmit a plurality of control signals. The control signal of the first high-side switch S1, the control signal of the second high-side switch S2, the control signal of the third high-side switch S3, the control signal of the first low-side switch S4, the control signal of the second low-side switch S5, and the control signal of the third low-side switch S6 are respectively denoted by V_{gs1}, V_{gs2}, V_{gs3}, V_{gs4}, V_{gs5}, and V_{gs6}.

The following will analyze the control signal V_{gs1} of the first high-side switch S1, the control signal V_{gs2} of the second high-side switch S2, the control signal V_{gs3} of the third high-side switch S3, the control signal V_{gs4} of the first low-side switch S4, the control signal V_{gs5} of the second low-side switch S5, and the control signal V_{gs6} of the third low-side switch S6. Please further refer to FIG. 1C, which depicts the timing diagrams of the control signals of the first switch circuit according to one embodiment of the present disclosure. As shown in FIG. 1C, in conjunction with FIG. 1B, the phase difference between the control signal V_{gs1} of the first high-side switch S1 and the control signal V_{gs4} of the first low-side switch S4 is 180 degrees; in other words, the control signal V_{gs1} of the first high-side switch S1 and the control signal V_{gs4} of the first low-side switch S4 are complementary. The phase difference between the control signal V_{gs2} of the second high-side switch S2 and the control signal V_{gs5} of the second low-side switch S5 is 180 degrees; in other words, the control signal V_{gs2} of the second high-side switch S2 and the control signal V_{gs5} of the second low-side switch S5 are complementary. The phase difference between the control signal V_{gs3} of the third high-side switch S3 and the control signal V_{gs6} of the third low-side switch S6 is 180 degrees; in other words, the control signal V_{gs3} of the third high-side switch S3 and the control signal V_{gs6} of the third low-side switch S6 are complementary.

The phase difference between the control signal V_{gs1} of the first high-side switch S1 and the control signal V_{gs2} of the second high-side switch S2 is 120 degrees, and the phase difference between the control signal V_{gs1} of the first high-side switch S1 and the control signal V_{gs3} of the third high-side switch S3 is 240 degrees; in other words, the phase difference between the control signal V_{gs2} of the second high-side switch S2 and the control signal V_{gs3} of the third high-side switch S3 is 120 degrees. Because of the complementary relationship between the control signal V_{gs1} of the first high-side switch S1 and the control signal V_{gs4} of the first low-side switch S4, the complementary relationship between the control signal V_{gs2} of the second high-side switch S2 and the control signal V_{gs5} of the second low-side switch S5, and the complementary relationship between the control signal V_{gs3} of the third high-side switch S3 and the control signal V_{gs6} of the third low-side switch S6, the phase difference between the control signal V_{gs4} of the first low-side switch S4 and the control signal V_{gs5} of the second low-side switch S5 is 120 degrees, and the phase difference between the control signal V_{gs4} of the first low-side switch S4 and the control signal V_{gs6} of the third low-side switch S6 is 240 degrees.

Considering the phase difference between the control signal V_{gs1} of the first high-side switch S1 and the control signal V_{gs2} of the second high-side switch S2, the phase difference between the control signal V_{gs1} of the first high-side switch S1 and the control signal V_{gs3} of the third high-side switch S3, the phase difference between the control signal V_{gs4} of the first low-side switch S4 and the control signal V_{gs5} of the second low-side switch S5, and the phase difference between the control signal V_{gs4} of the first low-side switch S4 and the control signal V_{gs6} of the third low-side switch S6, there is a phase difference between a current outputted by the first switch unit 21 and a current outputted by the first switch unit 22, and there is a phase difference between the current outputted by the first switch unit 21 and a current outputted by the first switch unit 23. In other words, three currents outputted by the first switch units 21, 22, and 23 are the three-phase current of the first switch circuit 20.

Because the on-time point of the first high-side switch S1, the on-time point of the second high-side switch S2, and the on-time point of the third high-side switch S3 are inconsistent, the on-time point of the first low-side switch S4, the on-time point of the second low-side switch S5, and the on-time point of the third low-side switch S6 are inconsistent, and the first switch circuit 20 generates an input current according to the input voltage, the input current of the first switch circuit 20 may be at least one of three currents outputted by the first switch units 21, 22, and 23.

Please refer to FIG. 1A again. The input current flows into at least one of the first resonant tank 31, the second resonant tank 32, and the third resonant tank 33, at least one of the first resonant tank 31, the second resonant tank 32, and the third resonant tank 33 generates a resonant current according to the input current, and the resonant current outputted into the voltage regulation circuit 40 by the resonant circuit 30 is at least one of the resonant current of the first resonant tank 31, the resonant current of the second resonant tank 32, and the resonant current of the third resonant tank 33. Thereafter, the primary side of the voltage regulation circuit 40 generates a first voltage and a first current according to the resonant current, and the value of the first current is less than the value of the resonant current; the secondary side of the voltage regulation circuit 40 generates a second voltage and a second current according to the first voltage and the first current.

In order to avoid the first high-side switch S1 and the first low-side switch S4 from being turned on synchronously, there is first deadtime t_{2d1} between the control signal V_{gs1} of the first high-side switch S1 and the control signal V_{gs4} of the first low-side switch S4. Specifically, there is the first deadtime t_{2d1} between the rising edge of the control signal V_{gs1} of the first high-side switch S1 and the falling edge of the control signal V_{gs4} of the first low-side switch S4, and there is the first deadtime t_{2d1} between the falling edge of the control signal V_{gs1} of the first high-side switch S1 and the rising edge of the control signal V_{gs4} of the first low-side switch S4. Correspondingly, there is the first deadtime t_{2d1} between the control signal V_{gs2} of the second high-side switch S2 and the control signal V_{gs5} of the second low-side switch S5, and there is the first deadtime t_{2d1} between the control signal V_{gs3} of the third high-side switch S3 and the control signal V_{gs6} of the third low-side switch S6. By the configuration of the first deadtime t_{d1}, the switching loss of switch components is reduced.

Please refer to FIG. 1D, which depicts the block diagram of the second switch circuit and the controller according to one embodiment of the present disclosure. As shown in FIG. 1D, the controller 70 is coupled to the first high-side rectifying switch SR1, the first low-side rectifying switch SR4, the second high-side rectifying switch SR2, the second low-side rectifying switch SR5, the third high-side rectifying switch SR3, and the third low-side rectifying switch SR6 to generate and transmit a plurality of control signals. The control signal of the first high-side rectifying switch SR1, the control signal of the second high-side rectifying switch SR2, the control signal of the third high-side rectifying switch SR3, the control signal of the first low-side rectifying switch SR4, the control signal of the second low-side rectifying switch SR5, and the control signal of the third low-side rectifying switch SR6 are respectively denoted by V_{gs7}, V_{gs8}, V_{gs9}, V_{gs10}, V_{gs11} and V_{gs12}.

The following will analyze the control signal V_{gs7} of the first high-side rectifying switch SR1, the control signal V_{gs5} of the second high-side rectifying switch SR2, the control signal V_{gs9}of the third high-side rectifying switch SR3, the control signal V_{gs10} of the first low-side rectifying switch SR4, the control signal V_{gs11} of the second low-side rectifying switch SR5, and the control signal V_{gs12} of the third low-side rectifying switch SR6. Please further refer to FIG. 1E, which depicts the timing diagrams of the control signals of the second switch circuit according to one embodiment of the present disclosure. As shown in FIG. 1E, in conjunction with FIG. 1D, the phase difference between the control signal V_{gs7} of the first high-side rectifying switch SR1 and the control signal V_{gs10} of the first low-side rectifying switch SR4 is 180 degrees; in other words, the control signal V_{gs7} of the first high-side rectifying switch SR1 and the control signal V_{gs10} of the first low-side rectifying switch SR4 are complementary. The phase difference between the control signal V_{gs5} of the second high-side rectifying switch SR2 and the control signal V_{gs11} of the second low-side rectifying switch SR5 is 180 degrees; in other words, the control signal V_{gs8}of the second high-side rectifying switch SR2 and the control signal V_{gs11} of the second low-side rectifying switch SR5 are complementary. The phase difference between the control signal V_{gs9} of the third high-side rectifying switch SR3 and the control signal V_{gs12} of the third low-side rectifying switch SR6 is 180 degrees; in other words, the control signal V_{gs9} of the third high-side rectifying switch SR3 and the control signal V_{gs12} of the third low-side rectifying switch SR6 are complementary.

The phase difference between the control signal V_{gs7} of the first high-side rectifying switch SR1 and the control signal V_{gs5} of the second high-side rectifying switch SR2 is 120 degrees, and the phase difference between the control signal V_{gs7} of the first high-side rectifying switch SR1 and the control signal V_{gs9} of the third high-side rectifying switch SR3 is 240 degrees; in other words, the phase difference between the control signal V_{gs5} of the second high-side rectifying switch SR2 and the control signal V_{gs9} of the third high-side rectifying switch SR3 is 120 degrees. Because of the complementary relationship between the control signal V_{gs7} of the first high-side rectifying switch SR1 and the control signal V_{gs10} of the first low-side rectifying switch SR4, the complementary relationship between the control signal V_{gs5} of the second high-side rectifying switch SR2 and the control signal V_{gs11} of the second low-side rectifying switch SR5, and the complementary relationship between the control signal V_{gs9} of the third high-side rectifying switch SR3 and the control signal V_{gs12} of the third low-side rectifying switch SR6, the phase difference between the control signal V_{gs10} of the first low-side rectifying switch SR4 and the control signal V_{gs11} of the second low-side rectifying switch SR5 is 120 degrees, and the phase difference between the control signal V_{gs10} of the first low-side rectifying switch SR4 and the control signal V_{gs12} of the third low-side rectifying switch SR6 is 240 degrees.

In order to avoid the first high-side rectifying switch SR1 and the first low-side rectifying switch SR4 from being turned on synchronously, there is second deadtime t₂₂ between the control signal V_{gs7} of the first high-side rectifying switch SR1 and the control signal V_{gs10} of the first low-side rectifying switch SR4. Specifically, there is the second deadtime t₂₂ between the rising edge of the control signal V_{gs7} of the first high-side rectifying switch SR1 and the falling edge of the control signal V_{gs10} of the first low-side rectifying switch SR4, and there is the second deadtime t₂₂ between the falling edge of the control signal V_{gs7} of the first high-side rectifying switch SR1 and the rising edge of the control signal V_{gs10} of the first low-side rectifying switch SR4. Correspondingly, there is the second deadtime t₂₂ between the control signal V_{gs5} of the second high-side rectifying switch SR2 and the control signal V_{gs11} of the second low-side rectifying switch SR5, and there is the second deadtime t₂₂ between the control signal V_{gs9} of the third high-side rectifying switch SR3 and the control signal V_{gs12} of the third low-side rectifying switch SR6.

By the configuration of the second deadtime t_{d2}, the switching loss of switch components is reduced.

According to the timing diagrams shown in FIG. 1C and FIG. 1E, in conjunction with FIG. 1B and FIG. 1D, the timing of the first switch unit 21 is consistent with the timing of the second switch unit 51, the timing of the first switch unit 22 is consistent with the timing of the second switch unit 52, and the timing of the first switch unit 23 is consistent with the timing of the second switch unit 53. In other words, the timing of the control signals of the first switch circuit 20 located on the primary side of the voltage regulation circuit 40 is consistent with the timing of the control signals of the second switch circuit 50 located on the secondary side of the voltage regulation circuit 40.

Please refer to FIG. 1A again. Because the on-time point of the first high-side rectifying switch SR1, the on-time point of the second high-side rectifying switch SR2, and the on-time point of the third high-side rectifying switch SR3 are inconsistent, and the on-time point of the first low-side rectifying switch SR4, the on-time point of the second low-side rectifying switch SR5, and the on-time point of the third low-side rectifying switch SR6 are inconsistent, the second voltage generated by the secondary side of the voltage regulation circuit 40 is inputted into at least one of the second switch units 51, 52, and 53. Thereafter, at least one of the second switch units 51, 52, and 53 generates an output current according to the second voltage, and the output current separately flows into the output capacitor Cout and the load resistance RL to generate an output voltage.

The following will elaborate the operation mechanism of the resonant converter with reference to FIG. 1A, FIG. 1C and FIG. 1E. From a time point to to a time point ti, the first high-side switch S1 is turned off, and the first low-side switch S4 is turned on; the second high-side switch S2 is turned off, and the second low-side switch S5 is turned on; the third high-side switch S3 is turned on, and the third low-side switch S6 is turned off. The third high-side switch S3 generates and transmits the input current to the third resonant tank 33 according to the input voltage, and the third resonant tank 33 generates the resonant current according to the input current of the third high-side switch S3. Thereafter, the primary side of the third transformer T3 generates the first voltage and the first current according to the resonant current of the third resonant tank 33, and the secondary side of the third transformer T3 generates the second voltage and the second current according to the first voltage and the first current.

Correspondingly, the first high-side rectifying switch SR1 is turned off, and the first low-side rectifying switch SR4 is turned on; the second high-side rectifying switch SR2 is turned off, and the second low-side rectifying switch SR5 is turned on; the third high-side rectifying switch SR3 is turned on, and the third low-side rectifying switch SR6 is turned off. The third high-side rectifying switch SR3 generates the output current according to the second voltage of the secondary side of the third transformer T3, and the output current is inputted into the output capacitor Cout and the load resistance RL to generate the output voltage.

From the time point ti to a time point t₂₂, the first high-side switch S1 is turned on, and the first low-side switch S4 is turned off; the second high-side switch S2 is turned off, and the second low-side switch S5 is turned on; the third high-side switch S3 is turned on, and the third low-side switch S6 is turned off. The first high-side switch S1 and the third high-side switch S3 separately generate and transmit the input currents to the first resonant tank 31 and the third resonant tank 33 according to the input voltage, the first resonant tank 31 generates the resonant current according to the input current of the first high-side switch S1, and the third resonant tank 33 generates the resonant current according to the input current of the third high-side switch S3. Thereafter, the primary side of the first transformer T1 and the primary side of the second transformer T2 separately generate the first voltages and the first currents according to the resonant current of the first resonant tank 31, and the primary side of the third transformer T3 generates the first voltage and the first current according to the resonant current of the third resonant tank 33. The secondary side of the first transformer T1 generates the second voltage and the second current according to the first voltage and the first current of the primary side of the first transformer T1, the secondary side of the second transformer T2 generates the second voltage and the second current according to the first voltage and the first current of the primary side of the second transformer T2, and the secondary side of the third transformer T3 generates the second voltage and the second current according to the first voltage and the first current of the primary side of the third transformer T3.

Correspondingly, the first high-side rectifying switch SR1 is turned on, and the first low-side rectifying switch SR4 is turned off; the second high-side rectifying switch SR2 is turned off, and the second low-side rectifying switch SR5 is turned on; the third high-side rectifying switch SR3 is turned on, and the third low-side rectifying switch SR6 is turned off. The first high-side rectifying switch SR1 generates the output current according to the second voltage of the secondary side of the first transformer T1, the third high-side rectifying switch SR3 generates the output current according to the second voltage of the secondary side of the third transformer T3, and the output current of the first high-side rectifying switch SR1 and the output current of the third high-side rectifying switch SR3 are inputted into the output capacitor Cout and the load resistance RL to generate the output voltage.

From the time point t₂₂ to a time point t₂₃, the first high-side switch S1 is turned on, and the first low-side switch S4 is turned off; the second high-side switch S2 is turned off, and the second low-side switch S5 is turned on; the third high-side switch S3 is turned off, and the third low-side switch S6 is turned on. The first high-side switch S1 generates and transmits the input current to the first resonant tank 31 according to the input voltage, and the first resonant tank 31 generates the resonant current according to the input current of the first high-side switch S1. Thereafter, the primary side of the first transformer T1 generates the first voltage and the first current according to the resonant current of the first resonant tank 31; the secondary side of the first transformer T1 generates the second voltage and the second current according to the first voltage and the first current of the primary side of the first transformer T1.

Correspondingly, the first high-side rectifying switch SR1 is turned on, and the first low-side rectifying switch SR4 is turned off; the second high-side rectifying switch SR2 is turned off, and the second low-side rectifying switch SR5 is turned on; the third high-side rectifying switch SR3 is turned off, and the third low-side rectifying switch SR6 is turned on. The first high-side rectifying switch SR1 generates the output current according to the second voltage of the secondary side of the first transformer T1, and the output current of the first high-side rectifying switch SR1 is inputted into the output capacitor Cout and the load resistance RL to generate the output voltage.

From the time point t₂₃ to a time point t₂₄, the first high-side switch S1 is turned on, and the first low-side switch S4 is turned off; the second high-side switch S2 is turned on, and the second low-side switch S5 is turned off; the third high-side switch S3 is turned off, and the third low-side switch S6 is turned on. The first high-side switch S1 generates and transmits the input current to the first resonant tank 31 according to the input voltage, and the second high-side switch S2 generates and transmits the input current to the second resonant tank 32 according to the input voltage; the first resonant tank 31 generates the resonant current according to the input current of the first high-side switch S1, and the second resonant tank 32 generates the resonant current according to the input current of the second high-side switch S2. Thereafter, the primary side of the first transformer T1 generates the first voltage and the first current according to the resonant current of the first resonant tank 31, and the primary side of the second transformer T2 and the primary side of the third transformer T3 separately generate the first voltage and the first current according to the resonant current of the first resonant tank 31 and the resonant current of the second resonant tank 32. The secondary side of the first transformer T1 generates the second voltage and the second current according to the first voltage and the first current of the primary side of the first transformer T1, the secondary side of the second transformer T2 generates the second voltage and the second current according to the first voltage and the first current of the primary side of the second transformer T2, and the secondary side of the third transformer T3 generates the second voltage and the second current according to the first voltage and the first current of the primary side of the third transformer T3.

Correspondingly, the first high-side rectifying switch SR1 is turned on, and the first low-side rectifying switch SR4 is turned off; the second high-side rectifying switch SR2 is turned on, and the second low-side rectifying switch SR5 is turned off; the third high-side rectifying switch SR3 is turned off, and the third low-side rectifying switch SR6 is turned on. The first high-side rectifying switch SR1 generates the output current according to the second voltage of the secondary side of the first transformer T1, the second high-side rectifying switch SR2 generates the output current according to the second voltage of the secondary side of the second transformer T2, and the output current of the first high-side rectifying switch SR1 and the output current of the second high-side rectifying switch SR2 are inputted into the output capacitor Cout and the load resistance RL to generate the output voltage.

From the time point t₂₄ to a time point t₅, the first high-side switch S1 is turned off, and the first low-side switch S4 is turned on; the second high-side switch S2 is turned on, and the second low-side switch S5 is turned off; the third high-side switch S3 is turned off, and the third low-side switch S6 is turned on. The second high-side switch S2 generates and transmits the input current to the second resonant tank 32 according to the input voltage, and the second resonant tank 32 generates the resonant current according to the input current of the second high-side switch S2. Thereafter, the primary side of the second transformer T2 generates the first voltage and the first current according to the resonant current of the second resonant tank 32; the secondary side of the second transformer T2 generates the second voltage and the second current according to the first voltage and the first current of the primary side of the second transformer T2.

Correspondingly, the first high-side rectifying switch SR1 is turned off, and the first low-side rectifying switch SR4 is turned on; the second high-side rectifying switch SR2 is turned on, and the second low-side rectifying switch SR5 is turned off; the third high-side rectifying switch SR3 is turned off, and the third low-side rectifying switch SR6 is turned on. The second high-side rectifying switch SR2 generates the output current according to the second voltage of the secondary side of the second transformer T2, and the output current of the second high-side rectifying switch SR2 is inputted into the output capacitor Cout and the load resistance RL to generate the output voltage.

From the time point t₂ₛ to a time point t6, the first high-side switch S1 is turned off, and the first low-side switch S4 is turned on; the second high-side switch S2 is turned on, and the second low-side switch S5 is turned off; the third high-side switch S3 is turned on, and the third low-side switch S6 is turned off. The second high-side switch S2 generates and transmits the input current to the second resonant tank 32 according to the input voltage, and the third high-side switch S3 generates and transmits the input current to the third resonant tank 33 according to the input voltage; the second resonant tank 32 generates the resonant current according to the input current of the second high-side switch S2, and the third resonant tank 33 generates the resonant current according to the input current of the third high-side switch S3. Thereafter, the primary side of the second transformer T2 generates the first voltage and the first current according to the resonant current of the second resonant tank 32; the primary side of the third transformer T3 generates the first voltage and the first current according to the resonant current of the third resonant tank 33. The secondary side of the second transformer T2 generates the second voltage and the second current according to the first voltage and the first current of the primary side of the second transformer T2, and the secondary side of the third transformer T3 generates the second voltage and the second current according to the first voltage and the first current of the primary side of the third transformer T3.

Correspondingly, the first high-side rectifying switch SR1 is turned off, and the first low-side rectifying switch SR4 is turned on; the second high-side rectifying switch SR2 is turned on, and the second low-side rectifying switch SR5 is turned off; the third high-side rectifying switch SR3 is turned on, and the third low-side rectifying switch SR6 is turned off. The second high-side rectifying switch SR2 generates the output current according to the second voltage of the secondary side of the second transformer T2, the third high-side rectifying switch SR3 generates the output current according to the second voltage of the secondary side of the third transformer T3, and the output current of the second high-side rectifying switch SR2 and the output current of the third high-side rectifying switch SR3 are inputted into the output capacitor Cout and the load resistance RL to generate the output voltage.

Please refer to FIG. 1F, which depicts the timing diagrams of the input current, the resonant current, a magnetizing current, and the second current according to one embodiment of the present disclosure. As shown in FIG. 1F, in conjunction with FIG. 1A, the input current of the first switch unit 21 is denoted by iₚₕ₁, the input current of the first switch unit 22 is denoted by iₚₕ₂, and the input current of the first switch unit 23 is denoted by iₚₕ₃; the current flowing into the primary side of the voltage regulation circuit 40 is denoted by iₚᵣᵢ, the magnetizing current passing through the magnetizing inductor is denoted by i_{Lm}, and the second current generated by the secondary side of the voltage regulation circuit 40 is denoted by i_{sec}. There is a first phase difference between the input current iₚₕ₁ of the first switch unit 21 and the input current iₚₕ₂ of the first switch unit 22, and the first phase difference is 120 degrees; there is a second phase difference between the input current iₚₕ₁ of the first switch unit 21 and the input current iₚₕ₃ of the first switch unit 23, and the second phase difference is 240 degrees. The timing of the current iₚᵣᵢ flowing into the primary side of the voltage regulation circuit 40 is consistent with the timing of the second current i_{sec} generated by the secondary side of the voltage regulation circuit 40. Because the primary side coil winding set 41A is coupled to the magnetizing inductor Lm1 in parallel, the peak value of the magnetizing current i_{L}m of the magnetizing inductor Lm1 is less than the peak value of the current iₚᵣᵢ flowing into the primary side of the voltage regulation circuit 40.

Please refer to FIG. 1G, which depicts the timing diagrams of the control signals of the first high-side switch and the first high-side rectifying switch according to one embodiment of the present disclosure. As shown in FIG. 1G, the on-time of the control signal V_{gs7} of the first high-side rectifying switch SR1 is less than the on-time of the control signal V_{gs1} of the first high-side switch S1. Specifically, the start time point of the control signal V_{gs7} of the first high-side rectifying switch SR1 during the on-time thereof is shortened by a preset time interval tpl in comparison with the start time point of the control signal V_{gs1} of the first high-side switch S1 during the on-time thereof, and the end time point of the control signal V_{gs7} of the first high-side rectifying switch SR1 during the on-time thereof is shortened by the preset time interval tpl in comparison with the end time point of the control signal V_{gs1} of the first high-side switch S1 during the on-time thereof. By adjusting the on-time of the control signal V_{gs7} of the first high-side rectifying switch SR1 and the on-time of the control signal V_{gs1} of the first high-side switch S1, the false turn on of the second switch circuit 50 is avoided.

Similarly, the on-time of the control signal V_{gs5} of the second high-side rectifying switch SR2 is less than the on-time of the control signal V_{gs2} of the second high-side switch S2, and the on-time of the control signal V_{gs9} of the third high-side rectifying switch SR3 is less than the on-time of the control signal V_{gs3} of the third high-side switch S3. The on-time of the control signal V_{gs10} of the first low-side rectifying switch SR4 is less than the on-time of the control signal V_{gs4} of the first low-side switch S4, the on-time of the control signal V_{gs11} of the second low-side rectifying switch SR5 is less than the on-time of the control signal V_{gs5} of the second low-side switch S5, and the on-time of the control signal V_{gsl2} of the third low-side rectifying switch SR6 is less than the on-time of the control signal V_{gs6} of the third low-side switch S6.

In the resonant converter of the present embodiment, by the arrangement of the resonant circuit and the adjustments of the switching frequency, the ZVS or the ZCS is accomplished to improve the PCE of the power converter. By the configurations of the first deadtime and the second deadtime, the upper-arm switches (i.e., the high-side switches) and the lower-arm switches (i.e., the low-side switches) of the first switch units are prevented from being turned on synchronously, and the upper-arm switches (i.e., the high-side rectifying switches), and the lower-arm switches (i.e., the low-side rectifying switches) of the second switch units are prevented from being turned on synchronously to reduce the switching loss of the switch components.

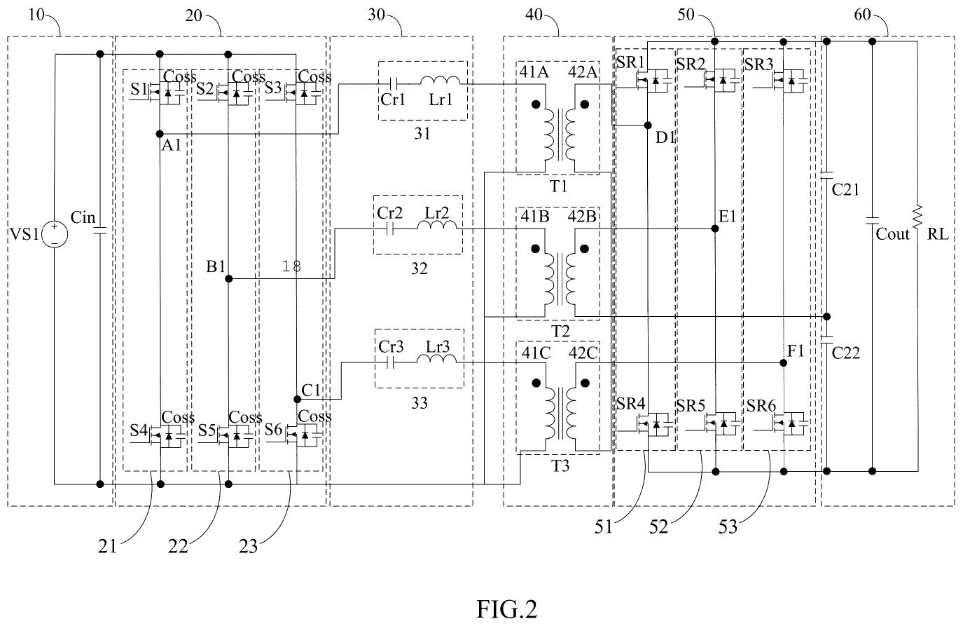

Please refer to FIG. 2, which depicts the circuit diagram of a half bridge-half bridge resonant converter. As shown in FIG. 2, the half bridge-half bridge resonant converter includes the input circuit 10, the first switch circuit 20, the resonant circuit 30, the voltage regulation circuit 40, the second switch circuit 50, and the output circuit 60; the component arrangement of the half bridge-half bridge resonant converter shown in FIG. 2 is similar to the component arrangement of the resonant converter shown in FIG. 1A, and the similarities between the half bridge-half bridge resonant converter and the resonant converter would not be repeated herein. However, there are still differences between the half bridge-half bridge resonant converter shown in FIG. 2 and the resonant converter shown in FIG. 1A as follows: the first resonant inductor Lr1 and the primary side coil winding set 41A of the first transformer T1 are coupled in series, the second resonant inductor Lr2 and the primary side coil winding set 41B of the second transformer T2 are coupled in series, and the third resonant inductor Lr3 and the primary side coil winding set 41C of the third transformer T3 are coupled in series; the output circuit 60 further includes two capacitors C21 and C22 which are coupled in series, and the secondary side coil winding set 42B of the second transformer T2 is coupled to the capacitors C21 and C22. The neutral point of the primary side of the voltage regulation circuit 40 and the neutral point of the secondary side of the voltage regulation circuit 40 in the halfbridge-half bridge resonant converter are respectively coupled to the groundterminal ofthe primary side ofthe voltage regulation circuit 40 and the ground terminal of the secondary side of the voltage regulation circuit 40, but the neutral point of the primary side of the voltage regulation circuit 40 and the neutral point of the secondary side of the voltage regulation circuit 40 in the resonant converter shown in FIG. pA are not coupled to the ground terminal of the primary side of the voltage regulation circuit 40 and the ground terminal of the secondary side ofthe voltage regulation circuit 40.

Under the same ZVS current condition, the specification of the half bridge-half bridge resonant converter and the specification of the resonant converter of the present disclosure may be set as Table 1 and Table 2.

TABLE 1

| | half bridge-half bridge | | resonant converter of | |
|---|---|---|---|---|
| Electrical Specification | resonant converter | | present disclosure | |
| Input Voltage | 400 | V | 400 | V |
| Output Voltage | 49.58 | V | 49.54 | V |
| Output Wattage | 10 | kW | 10 | kW |
| Switching Frequency | 100 | kHz | 100 | kHz |
| Operation Point | on a resonant point | | on a resonant point | |
| (full load) | | | | |
| Capacitance of | 190 | pF | 190 | pF |
| Capacitor Cₒₛₛ of | | | | |
| Primary Side Switch | | | | |
| (IMW65R050M2H) | | | | |
| Deadtime | 50 | ns | 50 | ns |
| Turns Ratio | 16:2 | | 16:2 | |
| Inductance of | 157.34 | μH | 420.32 | μH |
| Magnetizing Inductor | | | | |
| Capacitance of | 1.37 | μF | 597.41 | nF |
| Resonant Capacitor | | | | |
| Inductance of Resonant | 1.2 | μH | 1.2 | μH |
| Inductor | | | | |
| Leakage Inductance | 0.65 | μH | 0.64 | μH |

It should be noted that the turns ratio of the first transformer T1, the turns ratio of the second transformer T2, and the turns ratio of the third transformer T3 are all set as the turns ratio shown in Table 1, the first deadtime t_{2d1} shown in FIG. 1C and the second deadtime t_{2d2} shown in FIG. 1E are all set as the deadtime shown in Table 1; the inductance of the magnetizing inductors Lm1, Lm2, and Lm3 are all set as the inductance of the magnetizing inductor shown in Table 1, the capacitance of the first resonant capacitor Cr1, the capacitance of the second resonant capacitor Cr2, and the capacitance of the third resonant capacitor Cr3 are all set as the capacitance of the resonant capacitor shown in Table 1, and the inductance of the first resonant inductor Lr1, the inductance of the second resonant inductor Lr2, and the inductance of the third resonant inductor Lr3 are all set as the inductance of the resonant inductor shown in Table 1.

TABLE 2

| Magnetic Core | half bridge-half bridge | | resonant converter of | |
|---|---|---|---|---|
| Specification | resonant converter | | present disclosure | |
| Cross Section Area of | 174.04 | mm² | 174.04 | mm² |
| Central Rod of Magnetic | | | | |
| Core (Ae) | | | | |
| Materials | KF9 | | KF9 | |
| Maximum Magnetic | 0.25T | | 0.25T | |
| Flux Density Bmax | | | | |
| (assumed) | | | | |
| Primary Side Coil | 0.1*500 strands | | 0.1*500 strands | |
| Winding Set | | | | |
| Secondary Side Coil | copper sheet 0.6 mm | | copper sheet 0.6 mm | |
| Winding Set | | | | |
| Turns Ratio | 16:2 | | 16:2 | |
| Air Gap | 0.38 | mm | 0.12 | mm |

It should be noted that the primary side coil winding set 41A of the first transformer T1, the primary side coil winding set 41B of the second transformer T2, and the primary side coil winding set 41C of the third transformer T3 are all set as the primary side coil winding set shown in Table 2, and the secondary side coil winding set 42A of the first transformer T1, the secondary side coil winding set 42B of the second transformer T2, and the secondary side coil winding set 42C of the third transformer T3 are all set as the secondary side coil winding set shown in Table 2.

The performance of the halfbridge-halfbridge resonant converter and the performance of the resonant converter ofthe present disclosure are demonstrated by Table 3.

TABLE 3

| | half bridge-half bridge | resonant converter of |
|---|---|---|
| Performance Parameter | resonant converter | present disclosure |
| Current Peak Value on | 26.28 | 26.2 |
| Primary Side Switch (A) | | |
| Current Effective Value | 13.15 | 13.08 |
| on Primary Side Switch | | |
| (A) | | |
| Current Effective Value | 18.59 | 10.68 |
| on Primary Side | | |
| Transformer (A) | | |
| Number of Primary Side | 6 | 6 |
| Switch | | |
| Current Peak Value on | 208.2 | 207.59 |
| Secondary Side Switch | | |
| (A) | | |
| Current Effective Value | 103.97 | 103.76 |
| on Secondary Side | | |
| Switch (A) | | |
| Current Effective Value | 147.02 | 84.67 |
| on Secondary Side | | |
| Transformer (A) | | |
| Number of Secondary | 6 | 6 |
| Side Switch | | |
| Current Effective Value | 18.59 | 18.5 |
| of Resonant Inductor | | |
| (A) | | |

It should be noted that the primary side switch of Table 3 is the first switch circuit 20, and the primary side transformer of Table 3 is the primary side of the voltage regulation circuit 40; the secondary side switch of Table 3 is the second switch circuit 50, and the secondary side transformer of Table 3 is the secondary side of the voltage regulation circuit 40; the current effective value of the resonant inductor of Table 3 may be the current effective value of the first resonant inductor Lr1, the current effective value of the second resonant inductor Lr2 or the current effective value of the third resonant inductor Lr3. According to Table 3, the resonant converter of the present disclosure has less coil current stress on the voltage regulation circuit 40, and the air gap is also smaller.

The following will further explain the loss of the resonant converter of the present disclosure and the loss of the half bridge-half bridge resonant converter. In the half bridge-half bridge resonant converter, the loss of the magnetic core of the voltage regulation circuit 40 is 2.71 W, the copper loss of the primary side of the voltage regulation circuit 40 is 3.96 W, the copper loss of the secondary side of the voltage regulation circuit 40 is 9.11 W, and the total loss of the voltage regulation circuit 40 is 15.78 W; the magnetic field of the magnetic core of the voltage regulation circuit 40 is 0.175T. In the resonant converter of the present disclosure, the loss of the magnetic core of the voltage regulation circuit 40 is 8.43 W, the copper loss of the primary side of the voltage regulation circuit 40 is 1.31 W, the copper loss of the secondary side of the voltage regulation circuit 40 is 3 W, and the total loss of the voltage regulation circuit 40 is 12.74 W; the magnetic field of the magnetic core of the voltage regulation circuit 40 is 0.24T. According to the foregoing descriptions, the total loss of the voltage regulation circuit 40 is less when the resonant converter of the present disclosure is applied to a circuit with high voltages and high currents.

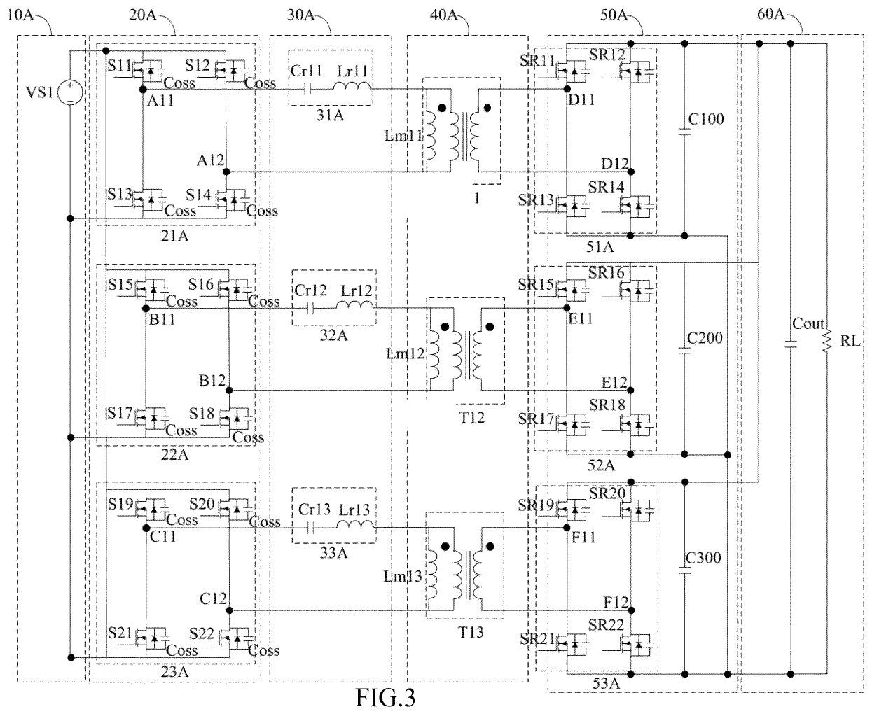

Please refer to FIG. 3, which depicts the circuit diagram of a full bridge-full bridge resonant converter. As shown in FIG. 3, the full bridge-full bridge resonant converter includes an input circuit 10A, a first switch circuit 20A, a resonant circuit 30A, a voltage regulation circuit 40A, a second switch circuit 50A, and an output circuit 60A.

The input circuit 10A includes the voltage source VS1, and the arrangement of the voltage source VS1 shown in FIG. 3 is similar to the arrangement of the voltage source VS1 shown in FIGS. 1A and is not repeated. The first switch circuit 20A includes three first switch units 21A, 22A and 23A which are coupled to one another in parallel. The first switch unit 21A includes two first high-side switches S11 and S12, two first low-side switches S13 and S14, and two first output nodes A11 and A12. The first high-side switch S11 and the first low-side switch S13 are coupled in series, and the first high-side switch S12 and the first low-side switch S14 are coupled in series; the first output node A11 is disposed between the first high-side switch S11 and the first low-side switch S13, and the first output node A12 is disposed between the first high-side switch S12 and the first low-side switch S14. The first switch unit 22A includes two second high-side switches S15 and S16, two second low-side switches S17 and S18, and two second output nodes B11 and B12. The second high-side switch S15 and the second low-side switch S17 are coupled in series, and the second high-side switch S16 and the second low-side switch S18 are coupled in series; the second output node B11 is disposed between the second high-side switch S15 and the second low-side switch S17, and the second output node B12 is disposed between the second high-side switch S16 and the second low-side switch S18. The first switch unit 23A includes two third high-side switches S19 and S20, two third low-side switches S21 and S22, and third output nodes C11 and C12. The third high-side switch S19 and the third low-side switch S21 are coupled in series, and the third high-side switch S20 and the third low-side switch S22 are coupled in series; the third output node C11 is disposed between the third high-side switch S19 and the third low-side switch S21, and the third output node C12 is disposed between the third high-side switch S20 and the third low-side switch S22.

The resonant circuit 30A includes a first resonant tank 31A, a second resonant tank 32A, and a third resonant tank 33A. The first resonant tank 31A includes a first resonant inductor Lr11 and a first resonant capacitor Cr11 which are coupled in series; the first resonant capacitor Cr11 is coupled to the first output node A11, and the first resonant inductor Lr11 is coupled to the primary side of the voltage regulation circuit 40A. The second resonant tank 32A includes a second resonant inductor Lr12 and a second resonant capacitor Cr12 which are coupled in series; the second resonant capacitor Cr12 is coupled to the second output node B11, and the second resonant inductor Lr12 is coupled to the primary side of the voltage regulation circuit 40A. The third resonant tank 33A includes a third resonant inductor Lr13 and a third resonant capacitor Cr13 which are coupled in series; the third resonant capacitor Cr13 is coupled to the third output node C11, and the third resonant inductor Lr13 is coupled to the primary side of the voltage regulation circuit 40A.

The voltage regulation circuit 40A includes a first transformer T11, a second transformer T12, and a third transformer T13. The primary side of the first transformer T11 is coupled to the first resonant inductor Lr11 and the first output node A12, and the primary side of the first transformer T11 includes a magnetizing inductor Lm11. The primary side of the second transformer T12 is coupled to the second resonant inductor Lr12 and the second output node B12, and the primary side of the second transformer T12 includes a magnetizing inductor Lm12. The primary side of the third transformer T13 is coupled to the third resonant inductor Lr13 and the third output node C12, and the primary side of the third transformer T13 includes a magnetizing inductor Lm13.

The second switch circuit 50A includes three second switch units 51A, 52A and 53A which are coupled to one another in parallel. The second switch unit 51A includes two first high-side rectifying switches SR11 and SR12, two first low-side rectifying switches SR13 and SR14, two first input nodes D11 and D12, and a capacitor C100; the first high-side rectifying switch SR11 and the first low-side rectifying switch SR13 are coupled in series, and the first high-side rectifying switch SR12 and the first low-side rectifying switch SR14 are coupled in series; the first input node D11 is disposed between the first high-side rectifying switch SR11 and the first low-side rectifying switch SR13, the first input node D12 is disposed between the first high-side rectifying switch SR12 and the first low-side rectifying switch SR14, and the first input nodes D11 tU D12 are coupled to the secondary side of the first transformer T11. One terminal of the capacitor C100 is coupled to the first high-side rectifying switch SR12, while the other terminal of the capacitor C100 is coupled to the first low-side rectifying switch SR14.

The second switch unit 52A includes two second high-side rectifying switches SR15 and SR16, two second low-side rectifying switches SR17 and SR18, two second input nodes E11 and E12, and a capacitor C200. The second high-side rectifying switch SR15 and the second low-side rectifying switch SR17 are coupled in series, and the second high-side rectifying switch SR16 and the second low-side rectifying switch SR18 are coupled in series; the second input node E11 is disposed between the second high-side rectifying switch SR15 and the second low-side rectifying switch SR17, the second input node E12 is disposed between the second high-side rectifying switch SR16 and the second low-side rectifying switch SR18, and the second input nodes E11 and E12 are coupled to the secondary side of the second transformer T12. One terminal of the capacitor C200 is coupled to the second high-side rectifying switch SR16, while the other terminal of the capacitor C200 is coupled to the second low-side rectifying switch SR18. The second switch unit 53A includes two third high-side rectifying switches SR19 and SR20, two third low-side rectifying switch SR21 and SR22, two third input nodes F11 and F12, and a capacitor C300. The third high-side rectifying switch SR19 and the third low-side rectifying switch SR21 are coupled in series, and the third high-side rectifying switch SR20 and the third low-side rectifying switch SR22 are coupled in series; the third input node F11 is disposed between the third high-side rectifying switch SR19 and the third low-side rectifying switch SR21, the third input node F12 is disposed between the third high-side rectifying switch SR20 and the third low-side rectifying switch SR22, and the third input nodes F11 and F12 are coupled to the secondary side of the third transformer T13. One terminal of the capacitor C300 is coupled to the third high-side rectifying switch SR20, while the other terminal of the capacitor C300 is coupled to the third low-side rectifying switch SR22.

The output circuit 60A includes the output capacitor Cout and the load resistance RL which are coupled to each other in parallel, and the arrangements of the output capacitor Cout and the load resistance RL shown in FIG. 3 are similar to the arrangements of the output capacitor Cout and the load resistance RL shown in FIG. 1A and are not repeated.

Under the same ZVS current condition, the specification of the full bridge-full bridge resonant converter may be set as Table 4 and Table 5, and the specification of the resonant converter of the present disclosure is shown as Table 1 and Table 2.

TABLE 4

| | full bridge-full bridge | |
|---|---|---|
| Electrical Specification | resonant converter | |
| Input Voltage | 400 | V |
| Output Voltage | 49.58 | V |
| Output Wattage | 10 | kW |
| Switching Frequency | 100 | kHz |
| Operation Point | on a resonant point | |
| (full load) | | |
| Capacitance of | 190 | pF |
| Capacitor Cₒₛₛ Of | | |
| Primary Side Switch | | |
| (IMW65R050M2H) | | |
| Deadtime | 50 | ns |
| Turns Ratio | 16:2 | |
| Inductance of | 157.34 | μH |
| Magnetizing Inductor | | |
| Capacitance of | 1.37 | μF |
| Resonant Capacitor | | |
| Inductance of Resonant | 1.2 | μH |
| Inductor | | |
| Leakage Inductance | 0.65 | μH |

It should be noted that the turns ratio of the first transformer T11, the turns ratio of the second transformer T12, and the turns ratio of the third transformer T13 are all set as the turns ratio shown in Table 4, the deadtime of the switch component of the first switch circuit 20A and the deadtime of the switch component of the second switch circuit 50A are all set as the deadtime shown in Table 4; the inductance of the magnetizing inductors Lm11, Lm12, and Lm13 are all set as the inductance of the magnetizing inductor shown in Table 4, the capacitance of the first resonant capacitor Cr11, the capacitance of the second resonant capacitor Cr12, and the capacitance of the third resonant capacitor Cr13 are all set as the capacitance of the resonant capacitor shown in Table 4, and the inductance of the first resonant inductor Lr11, the inductance of the second resonant inductor Lr12, and the inductance of the third resonant inductor Lr13 are all set as the inductance of the resonant inductor shown in Table 1.

TABLE 5

| Magnetic Core | half bridge-half bridge | |
|---|---|---|
| Specification | resonant converter | |
| Cross Section Area of | 174.04 | mm² |
| Central Rod of Magnetic | | |
| Core (Ae) | | |
| Materials | KF9 | |
| Maximum Magnetic | 0.25T | |
| Flux Density Bmax | | |
| (assumed) | | |
| Primary Side Coil | 0.1*500 strands | |
| Winding Set | | |
| Secondary Side Coil | copper sheet 0.6 mm | |
| Winding Set | | |
| Turns Ratio | 16:2 | |
| Air Gap | 0.38 | mm |

It should be noted that the primary side coil winding set of the first transformer T11, the primary side coil winding set of the second transformer T12, and the primary side coil winding set of the third transformer T13 are all set as the primary side coil winding set shown in Table 5, and the secondary side coil winding set of the first transformer T11, the secondary side coil winding set of the second transformer T12, and the secondary side coil winding set of the third transformer T13 are all set as the secondary side coil winding set shown in Table 5.

The performance of the full bridge-full bridge resonant converter is demonstrated by Table 6, and the performance of the resonant converter of the present disclosure is demonstrated by Table 3.

TABLE 6

| | full bridge-full bridge |
|---|---|
| Performance Parameter | resonant converter |
| Current Peak Value on | 14.13 |
| Primary Side Switch (A) | |
| Current Effective Value | 7.13 |
| on Primary Side Switch | |
| (A) | |
| Current Effective Value | 10.09 |
| on Primary Side | |
| Transformer (A) | |
| Number of Primary Side | 12 |
| Switch | |
| Current Peak Value on | 105.71 |
| Secondary Side Switch | |
| (A) | |
| Current Effective Value | 52.54 |
| on Secondary Side | |
| Switch (A) | |
| Current Effective Value | 74.2 |
| on Secondary Side | |
| Transformer (A) | |
| Number of Secondary | 12 |
| Side Switch | |
| Current Effective Value | 10.09 |
| of Resonant Inductor | |
| (A) | |

It should be noted that the primary side switch of Table 6 is the first switch circuit 20A, and the primary side transformer of Table 6 is the primary side of the voltage regulation circuit 40A; the secondary side switch of Table 6 is the second switch circuit 50A, and the secondary side transformer of Table 6 is the secondary side of the voltage regulation circuit 40A; the current effective value of the resonant inductor of Table 6 may be the current effective value of the first resonant inductor Lr11, the current effective value of the second resonant inductor Lr12 or the current effective value of the third resonant inductor Lr13. According to Table 6, the air gap of the full bridge-full bridge resonant converter is greater than the air gap of the resonant converter of the present disclosure although the coil current stress of the full bridge-full bridge resonant converter is less than the coil current stress of the resonant converter of the present disclosure.

The following will further explain the loss of the full bridge-full bridge resonant converter. In the full bridge-full bridge resonant converter, the loss of the magnetic core of the voltage regulation circuit 40A is 18.54 W, the copper loss of the primary side of the voltage regulation circuit 40A is 2.05 W, the copper loss of the secondary side of the voltage regulation circuit 40A is 3.9 W, and the total loss of the voltage regulation circuit 40A is 24.49 W; the magnetic field of the magnetic core of the voltage regulation circuit 40A is 0.35T. According to the foregoing descriptions, the total loss of the voltage regulation circuit 40A of the full bridge-full bridge resonant converter is still greater than the total loss of the voltage regulation circuit 40 of the resonant converter of the present disclosure.

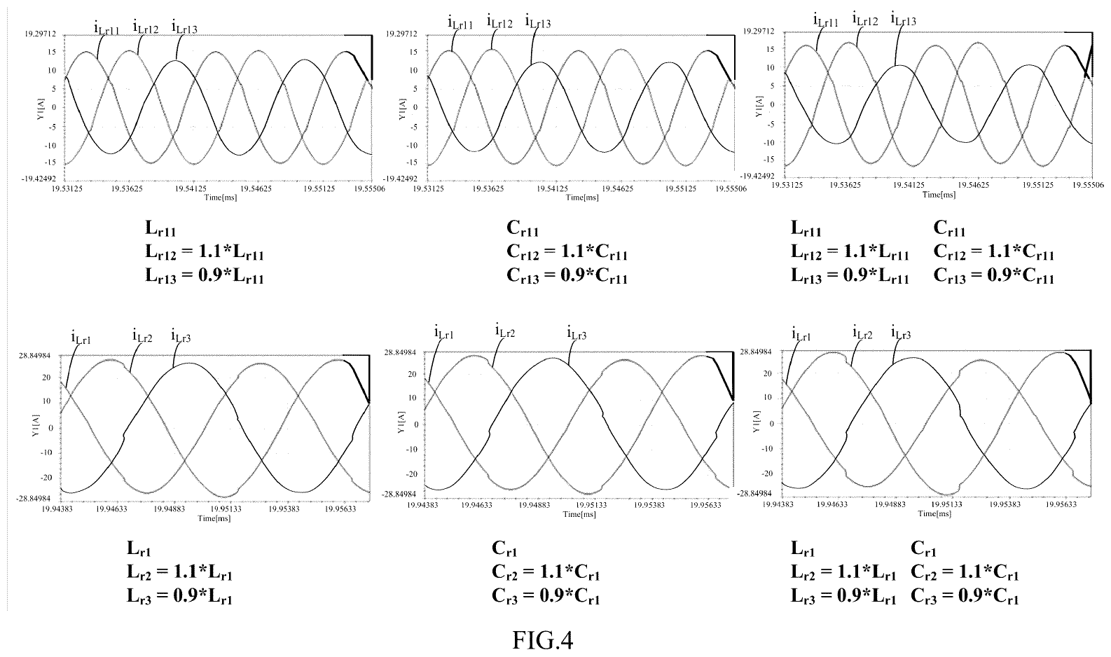

Please refer to FIG. 4, which depicts the error comparison diagrams of the resonant current of the resonant converter and the resonant current of the full bridge-full bridge resonant converter according to one embodiment of the present disclosure. FIG. 4 analyzes the resonant current of the resonant converter and the resonant current of the full bridge-full bridge resonant converter under the circumstances that there is an error in the inductance of the resonant inductor, there is an error in the capacitance of the resonant capacitor, and there are errors in both the inductance of the resonant inductor and the capacitance of the resonant capacitor. Herein, the standard values of the resonant currents of the first resonant tank 31, the second resonant tank 32, and the third resonant tank 33 in the resonant converter shown in FIG. 1A are all set as 26.18A, and the standard values of the resonant currents of the first resonant tank 31A, the second resonant tank 32A, and the third resonant tank 33A in the full bridge-full bridge resonant converter shown in FIG. 3 are all set as 14.12A.

As shown in the first part of FIG. 4, in conjunction with the resonant converter shown in FIG. 1A, the maximum value of the resonant current i_{Lr1} of the first resonant tank 31 is 25.58A, the maximum value of the resonant current 1_{Lr2} of the second resonant tank 32 is 25.95A, and the maximum value of the resonant current i_{Lr3} of the third resonant tank 33 is 27.06A, provided that the value of the inductance of the second resonant inductor Lr2 is 1.1 times the value of the inductance of the first resonant inductor Lr1 and the value of the inductance of the third resonant inductor Lr3 is 0.9 times the value of the inductance of the first resonant inductor Lr1. As shown in the first part of FIG. 4, in conjunction with the full bridge-full bridge resonant converter shown in FIG. 3, the maximum value of the resonant current i_{Lr1} of the first resonant tank 31A is 14.74A, the maximum value of the resonant current i_{Lr12} of the second resonant tank 32A is 12.61A, and the maximum value of the resonant current i_{Lr13} of the third resonant tank 33A is 15.03A, provided that the value of the inductance of the second resonant inductor Lr12 is 1.1 times the value of the inductance of the first resonant inductor Lr11 and the value of the inductance of the third resonant inductor Lr13 is 0.9 times the value of the inductance of the first resonant inductor Lr11.

As shown in the second part of FIG. 4, in conjunction with the resonant converter shown in FIG. 1A, the maximum value of the resonant current i_{Lr1} of the first resonant tank 31 is 25.5A, the maximum value of the resonant current i_{Lr2} of the second resonant tank 32 is 25.9A, and the maximum value of the resonant current i_{Lr3} of the third resonant tank 33 is 27.18A, provided that the value of the capacitance of the second resonant capacitor Cr2 is 1.1 times the value of the capacitance of the first resonant capacitor Cr1 and the value of the capacitance of the third resonant capacitor Cr3 is 0.9 times the value of the capacitance of the first resonant capacitor Cr1. As shown in the second part of FIG. 4, in conjunction with the full bridge-full bridge resonant converter shown in FIG. 3, the maximum value of the resonant current i_{Lr11} of the first resonant tank 31A is 15.01A, the maximum value of the resonant current i_{Lr12} of the second resonant tank 32A is 11.98A, and the maximum value of the resonant current i_{Lr13} of the third resonant tank 33A is 15.45A, provided that the value of the capacitance of the second resonant capacitor Cr12 is 1.1 times the value of the capacitance of the first resonant capacitor Cr11 and the value of the capacitance of the third resonant capacitor Cr13 is 0.9 times the value of the capacitance of the first resonant capacitor Cr11.

As shown in the third part of FIG. 4, in conjunction with the resonant converter shown in FIG. 1A, the maximum value of the resonant current i_{Lr1} of the first resonant tank 31 is 24.93A, the maximum value of the resonant current i_{Lr2} of the second resonant tank 32 is 25.75A, and the maximum value of the resonant current i_{Lr3} of the third resonant tank 33 is 28.09A, provided that the value of the inductance of the second resonant inductor Lr2 is 1.1 times the value of the inductance of the first resonant inductor Lr1, the value of the inductance of the third resonant inductor Lr3 is 0.9 times the value of the inductance of the first resonant inductor Lr1, the value of the capacitance of the second resonant capacitor Cr2 is 1.1 times the value of the capacitance of the first resonant capacitor Cr1, and the value of the capacitance of the third resonant capacitor Cr3 is 0.9 times the value of the capacitance of the first resonant capacitor Cr1. As shown in the third part of FIG. 4, in conjunction with the full bridge-full bridge resonant converter shown in FIG. 3, the maximum value of the resonant current i_{Lr11} of the first resonant tank 31A is 15.72A, the maximum value of the resonant current i_{Lr12} of the second resonant tank 32A is 10.54A, and the maximum value of the resonant current i_{Lr13} of the third resonant tank 33A is 16.46A, provided that the value of the inductance of the second resonant inductor Lr12 is 1.1 times the value of the inductance of the first resonant inductor Lr11, the value of the inductance of the third resonant inductor Lr13 is 0.9 times the value of the inductance of the first resonant inductor Lr11, the value of the capacitance of the second resonant capacitor Cr12 is 1.1 times the value of the capacitance of the first resonant capacitor Cr11, and the value of the capacitance of the third resonant capacitor Cr13 is 0.9 times the value of the capacitance of the first resonant capacitor Cr11.

According to the foregoing descriptions, the current deviations of the resonant converter of the present disclosure caused by the electronic component errors are less than the current deviations of the bridge-full bridge resonant converter caused by the electronic component errors; in other words, the range of the current variation of the resonant converter of the present disclosure is less than the range of the current variation of the full bridge-full bridge resonant converter.

Hence, the resonant converter of the present disclosure has higher tolerance for the current deviations caused by the electronic component errors.

In the present embodiment, the first transformer T1, the second transformer T2 and the third transformer T3 separately include magnetic cores. The primary side coil winding set 41A and the secondary side coil winding set 42A of the first transformer T1 share the magnetic core of the first transformer T1, the primary side coil winding set 41B and the secondary side coil winding set 42B of the second transformer T2 share the magnetic core of the second transformer T2, and the primary side coil winding set 41C and the secondary side coil winding set 42C of the third transformer T3 share the magnetic core of the third transformer T3.

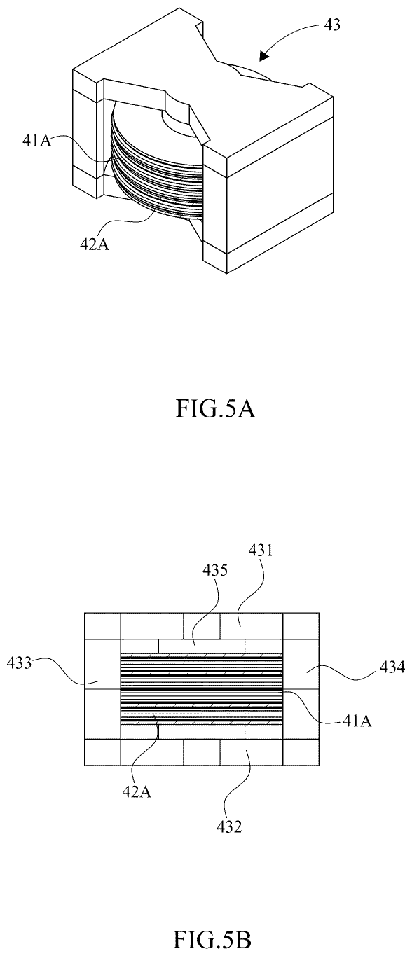

The following will elaborate the arrangements of the magnetic core of the first transformer T1, the magnetic core of the second transformer T2, and the magnetic core of the third transformer T3. Please refer to FIG. 5A and FIG. 5B, which depict the 3D diagram of the magnetic cores according to one embodiment of the present disclosure and the cross section diagram of the magnetic cores according to one embodiment of the present disclosure. As shown in FIG. 5A and FIG. 5B, taking the primary side coil winding set 41A and the secondary side coil winding set 42A of the first transformer T1 as an example, the magnetic core 43 of the first transformer T1 includes an upper cover 431, a lower cover 432, a first edge rod 433, a second edge rod 434, and a central rod 435. The first edge rod 433 and the second edge rod 434 are disposed between the upper cover 431 and the lower cover 432, and the upper cover 431, the lower cover 432, the first edge rod 433, and the second edge rod 434 collaboratively define accommodation space where the central rod 435 is disposed. The central rod 435 is disposed between the upper cover 431 and the lower cover 432, and the first edge rod 433 and the second edge rod 434 are located on two opposite sides of the central rod 435; in other words, the central rod 435 is disposed between the first edge rod 433 and the second edge rod 434. The primary side coil winding set 41A and the secondary side coil winding set 42A surround the magnetic core 43 in a clockwise direction or a counterclockwise direction; in other words, the primary side coil winding set 41A and the secondary side coil winding set 42A share the magnetic core 43. The magnetic core 43 of the first transformer T1, the magnetic core of the second transformer T2, and the magnetic core of the third transformer T3 are independent of one another, and the arrangement of the magnetic core of the second transformer T2 and the arrangement of the magnetic core of the third transformer T3 are the same as the arrangement of the magnetic core 43 of the first transformer T1 and are not repeated.

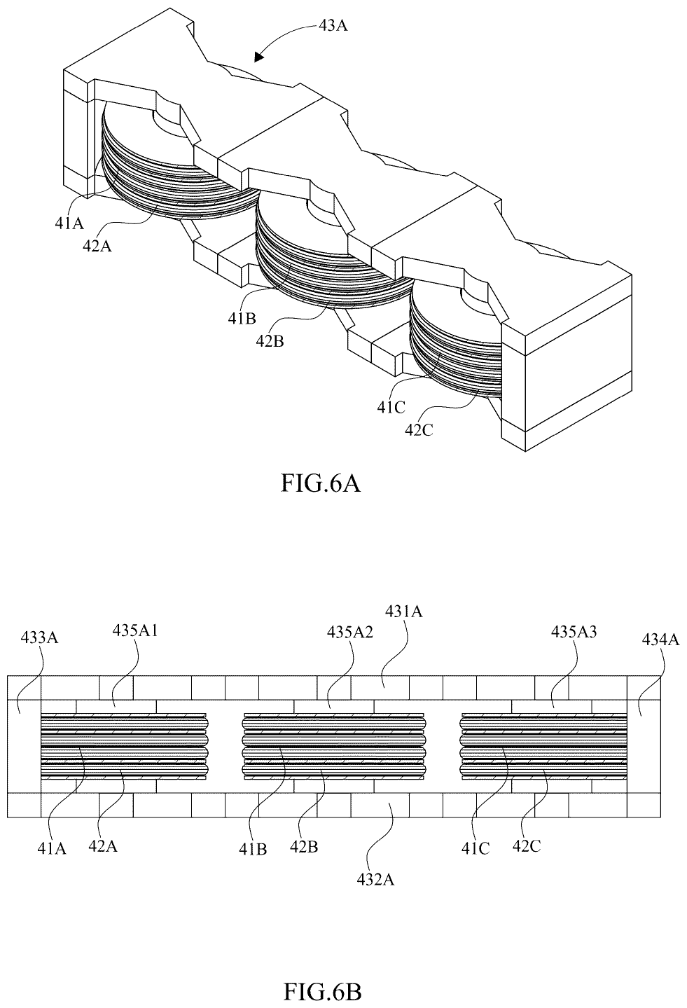

Please refer to FIG. 6A and FIG. 6B, which depict the 3D diagram of the magnetic cores according to another embodiment of the present disclosure and the cross section diagram of the magnetic cores according to another embodiment of the present disclosure. As shown in FIG. 6A and FIG. 6B, the primary side coil winding set 41A and the secondary side coil winding set 42Aof the first transformer T1, the primary side coil winding set 41B and the secondary side coil winding set 42B of the second transformer T2, and the primary side coil winding set 41C and the secondary side coil winding set 42C of the third transformer T3 share a magnetic core 43A; in other words, the first transformer T1, the second transformer T2, and the third transformer T3 share the magnetic core 43A. The magnetic core 43A includes an upper cover 431A, a lower cover 432A, a first edge rod 433A, a second edge rod 434A and a plurality of central rods, and the central rods are separate from one another and includes a first central rod 435A1, a second central rod 435A2, and a third central rod 435A3. The first edge rod 433A and the second edge rod 434A are disposed between the upper cover 431A and the lower cover 432A, the upper cover 431A, the lower cover 432A, the first edge rod 433A, and the second edge rod 434A collaboratively define accommodation space, and the first central rod 435A1, the second central rod 435A2, and the third central rod 435A3 are disposed in the accommodation space. The first central rod 435A1, the second central rod 435A2, and the third central rod 435A3 are disposed between the upper cover 431A and the lower cover 432A, the first central rod 435A1 and the third central rod 435A3 are located on two opposite sides of the second central rod 435A2, the first edge rod 433A and the second central rod 435A2 are located on two opposite sides of the first central rod 435A1, and the second central rod 435A2 and the second edge rod 434A are located on two opposite sides of the third central rod 435A3; in other words, the first central rod 435A1, the second central rod 435A2, and the third central rod 435A3 are disposed between the first edge rod 433A and the second edge rod 434A. The first central rod 435A1, the second central rod 435A2, and the third central rod 435A3 are not coupled to one another, and the first central rod 435A1 to the third central rod 435A3 are all provided with the air gaps.

The primary side coil winding set 41A and the secondary side coil winding set 42A of the first transformer T1, for example, surround the first central rod 435A1 in the clockwise direction, the primary side coil winding set 41B and the secondary side coil winding set 42B of the second transformer T2, for example, surround the second central rod 435A2 in the clockwise direction, and the primary side coil winding set 41C and the secondary side coil winding set 42C of the third transformer T3, for example, surround the third central rod 435A3 in the clockwise direction; in other words, the primary side coil winding set 41A and the secondary side coil winding set 42A of the first transformer T1 share the first central rod 435A1, the primary side coil winding set 41B and the secondary side coil winding set 42B of the second transformer T2 share the second central rod 435A2, and the primary side coil winding set 41C and the secondary side coil winding set 42C of the third transformer T3 share the third central rod 435A3.

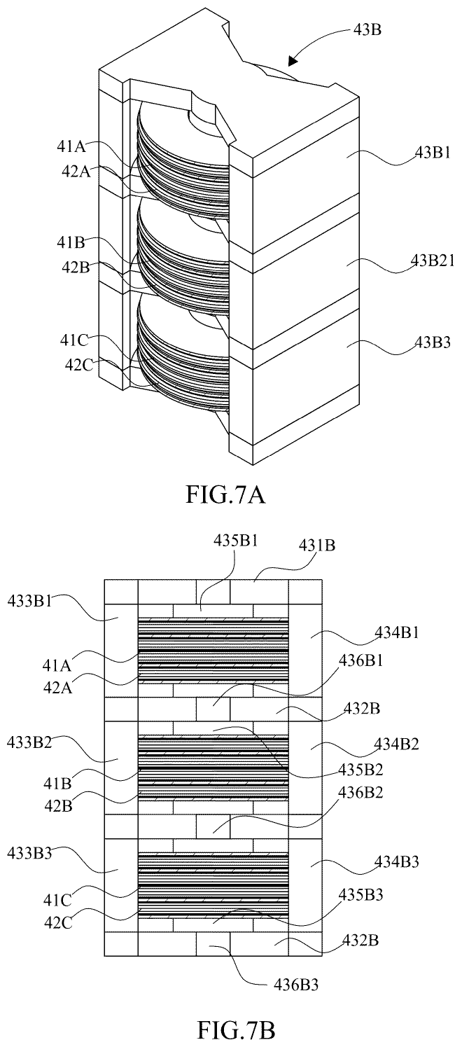

Please refer to FIG. 7A and FIG. 7B, which depict the 3D diagram of the magnetic cores according to a yet embodiment of the present disclosure and the cross section diagram of the magnetic cores according to a yet embodiment of the present disclosure. As shown in FIG. 7A and FIG. 7B, the third magnetic core 43B3 of the third transformer T3, the second magnetic core 43B2 of the second transformer T2, and the first magnetic core 43B1 of the first transformer T1 are sequentially disposed, and first magnetic core 43B1, the second magnetic core 43B2, and the third magnetic core 43B3 share an upper cover 431B and a lower cover 432B.

The first magnetic core 43B1 includes a first edge rod 433B1, a second edge rod 434B1, a first middle cover plate 436B1, and a first central rod 435B1. The first edge rod 433B1 and the second edge rod 434B1 are disposed between the upper cover 431B and the first middle cover plate 436B1, and the upper cover 431B, the first edge rod 433B1, the second edge rod 434B1, and the first middle cover plate 436B1 collaboratively define accommodation space where the first central rod 435B1 is disposed. The first edge rod 433B1 and the second edge rod 434B1 are disposed on two opposite sides of the first central rod 435B1; in other words, the first central rod 435B1 is disposed between the first edge rod 433B1 and the second edge rod 434B1. The primary side coil winding set 41A and the secondary side coil winding set 42A of the first transformer T1 surround the first central rod 435B1 in the clockwise direction or the counterclockwise direction; in other words, the primary side coil winding set 41A and the secondary side coil winding set 42A of the first transformer T1 share the first central rod 435B1.

The second magnetic core 43B2 is located under the first magnetic core 43B1 and includes a first edge rod 433B2, a second edge rod 434B2, a second middle cover plate 436B2, and a second central rod 435B2. The first edge rod 433B2 and the second edge rod 434B2 are disposed between the first middle cover plate 436B1 and the second middle cover plate 436B2, and the first edge rod 433B1, the second edge rod 434B1, the first middle cover plate 436B1, and the second middle cover plate 436B2 collaboratively define accommodation space where the second central rod 435B2 is disposed. The first edge rod 433B2 and the second edge rod 434B2 are disposed on two opposite sides of the second central rod 435B2; in other words, the second central rod 435B2 is disposed between the first edge rod 433B2 and the second edge rod 434B2. The primary side coil winding set 41B and the secondary side coil winding set 42B of the second transformer T2 surround the second central rod 435B2 in the clockwise direction or the counterclockwise direction; in other words, the primary side coil winding set 41B and the secondary side coil winding set 42B of the second transformer T2 share the second central rod 435B2.

The third magnetic core 43B3 is located under second magnetic core 43B3 and includes a first edge rod 433B3, a second edge rod 434B3, a third middle cover plate 436B3, and a third central rod 435B3. The first edge rod 433B3 and the second edge rod 434B3 are disposed between the second middle cover plate 436B2 and the lower cover 432B, and the first edge rod 433B3, the second edge rod 434B3, the second middle cover plate 436B2, and the lower cover 432B collaboratively define accommodation space where the third central rod 435B3 is disposed. The first edge rod 433B3 and the second edge rod 434B3 are located on two opposite sides of the third central rod 435B3; in other words, the third central rod 435B3 is disposed between the first edge rod 433B3 and the second edge rod 434B3. The third middle cover plate 436B3 serves as the lower cover 432B. The primary side coil winding set 41C and the secondary side coil winding set 42C of the third transformer T3 surround the third central rod 435B3 in the clockwise direction or the counterclockwise direction; in other words, the primary side coil winding set 41C and the secondary side coil winding set 42C of the third transformer T3 share the third central rod 435B3.

The first central rod 435B1, the second central rod 435B2, and the third central rod 435B3 are not coupled to one another, and the first central rod 435B1 to the third central rod 435B3 are all provided with the air gaps.

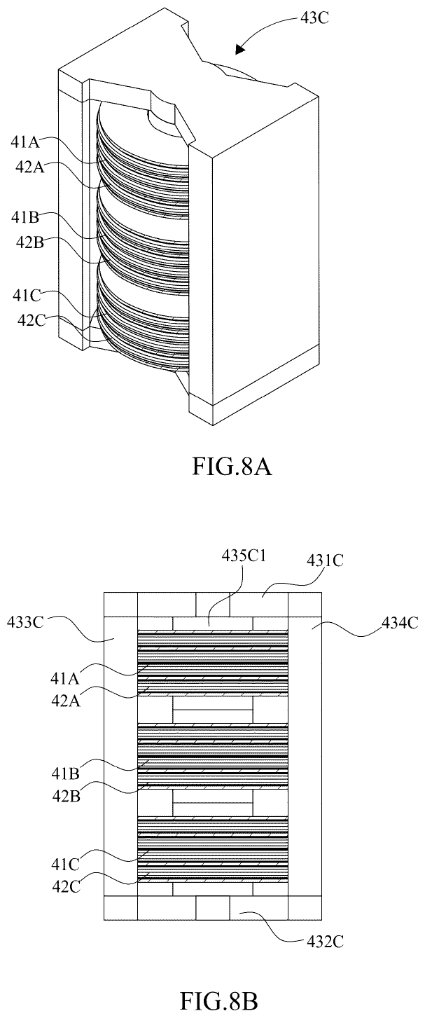

Please refer to FIG. 8A and FIG. 8B, which depict the 3D diagram of the magnetic cores according to a still embodiment of the present disclosure and the cross section diagram of the magnetic cores according to a still embodiment of the present disclosure. As shown in FIG. 8A and FIG. 8B, the primary side coil winding set 41A and the secondary side coil winding set 42A of the first transformer T1, the primary side coil winding set 41B and the secondary side coil winding set 42B of the second transformer T2, and the primary side coil winding set 41C and the secondary side coil winding set 42C of the third transformer T3 share a magnetic core 43C; in other words, the first transformer T1, the second transformer T2, and the third transformer T3 share the magnetic core 43C. The arrangement of the magnetic core 43C shown in FIG. 8A and FIG. 8B is similar to the arrangement of the magnetic core 43A shown in FIG. 6A and FIG. 6B, and the similarities between the magnetic core 43C shown in FIG. 8A and FIG. 8B and the magnetic core 43A shown in FIG. 6A and FIG. 6B would not be repeated herein. However, there are still differences between the magnetic core 43C shown in FIG. 8A and FIG. 8B and the magnetic core 43A shown in FIG. 6A and FIG. 6B as follows: the first central rod 435C1, the second central rod 435C2, and the third central rod 435C3 are connected to one another and coupled to one another.

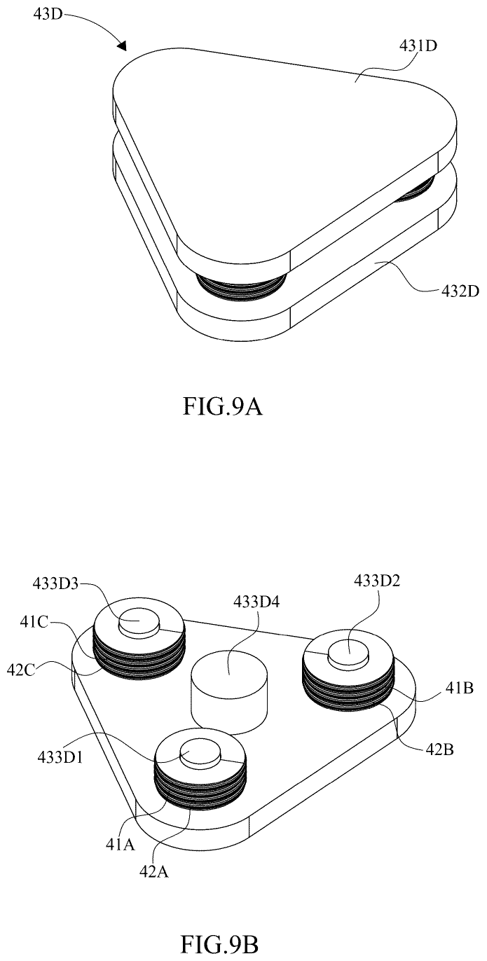

Please refer to FIG. 9A and FIG. 9B, which depict the 3D diagram of the magnetic cores according to yet another embodiment of the present disclosure and the cross section diagram of the magnetic cores according to yet another embodiment of the present disclosure. As shown in FIG. 9A and FIG. 9B, the primary side coil winding set 41A and the secondary side coil winding set 42A of the first transformer T1, the primary side coil winding set 41B and the secondary side coil winding set 42B of the second transformer T2, and the primary side coil winding set 41C and the secondary side coil winding set 42C of the third transformer T3 share a magnetic core 43D; in other words, the first transformer T1, the second transformer T2, and the third transformer T3 share the magnetic core 43D. The magnetic core 43D includes an upper cover 431D, a lower cover 432D, and a plurality of central rods, and the central rods includes a first central rod 433D1, a second central rod 433D2, a third central rod 433D3, and a fourth central rod 433D4. The first central rod 433D1, the second central rod 433D2, the third central rod 433D3, and the fourth central rod 433D4 are disposed between the upper cover 431D and the lower cover 432D. The first central rod 433D1, the second central rod 433D2, and the third central rod 433D3 surround the fourth central rod 433D4, and the first central rod 433D1, the second central rod 433D2, and third central rod 433D3 are not coupled to one another. The first central rod 433D1, the second central rod 433D2, and the third central rod 433D3 are separately coupled to the fourth central rod 433D4; the first central rod 433D1, the second central rod 433D2, and the third central rod 433D3 are separately provided with the air gaps, and the fourth central rod 433D4 is not provided with the air gap.

The primary side coil winding set 41A and the secondary side coil winding set 42A of the first transformer T1 surround the first central rod 433D1 in the clockwise direction or the counterclockwise direction, the primary side coil winding set 41B and the secondary side coil winding set 42B of the second transformer T2 surround the second central rod 433D2 in the clockwise direction or the counterclockwise direction, and the primary side coil winding set 41C and the secondary side coil winding set 42C of the third transformer T3 surround the third central rod 433D3 in the clockwise direction or the counterclockwise direction.

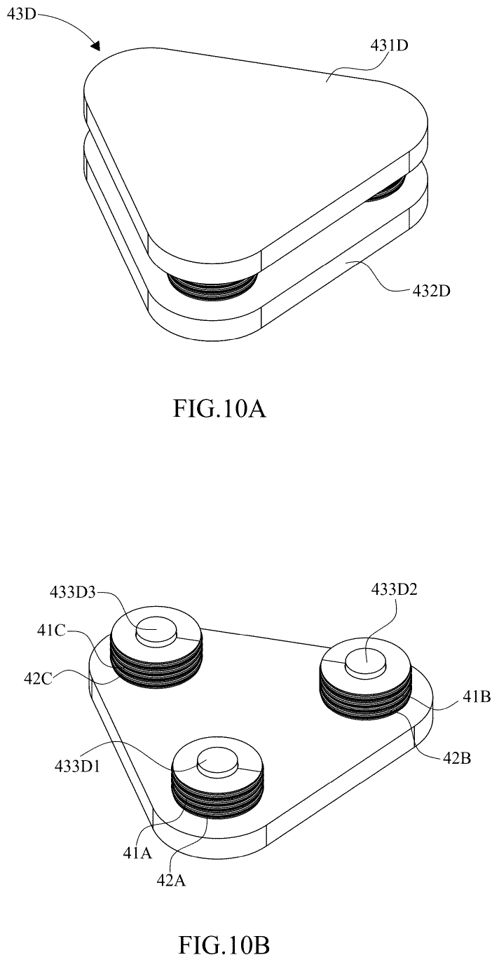

Please refer to FIG. 10A and FIG. 10B, which depict the 3D diagram of the magnetic cores according to still another embodiment of the present disclosure and the cross section diagram of the magnetic cores according to still another embodiment of the present disclosure. As shown in FIG. 10A and FIG. 10B, the primary side coil winding set 41A and the secondary side coil winding set 42A of the first transformer T1, the primary side coil winding set 41B and the secondary side coil winding set 42B of the second transformer T2, and the primary side coil winding set 41C and the secondary side coil winding set 42C of the third transformer T3 share the magnetic core 43D; the arrangement of the magnetic core 43D shown in FIG. 10A and FIG. 10B is similar to the arrangement of the magnetic core 43D shown in FIG. 9A and FIG. 9B, and the similarities between the magnetic core 43D shown in FIG. 10A and FIG. 10B and the magnetic core 43D shown in FIG. 9A and FIG. 9B would not be repeated herein. However, there are still differences between the magnetic core 43D shown in FIG. 10A and FIG. 10B and the magnetic core 43D shown in FIG. 9A and FIG. 9B as follows: there is not any fourth central rod 433D4, the first central rod 433D1, the second central rod 433D2, and the third central rod 433D3 are coupled to one another, and the first central rod 433D1, the second central rod 433D2, and the third central rod 433D3 are separately provided with the air gaps.

In view of the above description, the resonant converter of the present disclosure fulfills the ZVS or the ZCS by the arrangement of the resonant circuit, thereby reducing the switching loss of the switch components and the power loss of the power converter.

What is claimed is:

1. A resonant converter comprising:
an input circuit providing an input voltage;
a first switch circuit coupled to the input circuit and comprising a plurality of first switch units, wherein each of the first switch units comprises an output node;
a resonant circuit comprising a plurality of resonant tanks each of which comprises a resonant capacitor and a resonant inductor, wherein the resonant capacitor and the resonant inductor are coupled in series, and the resonant inductors are coupled to the output nodes by wye connection;
a voltage regulation circuit, wherein there are a plurality of connection nodes between a primary side of the voltage regulation circuit and the resonant capacitors, and the resonant capacitors are coupled to the primary side of the voltage regulation circuit by the wye connection based on the connection nodes;
a second switch circuit comprising a plurality of second switch units each of which comprises an input node, wherein the input nodes are coupled to a secondary side of the voltage regulation circuit by delta connection; and
an output circuit coupled to the second switch circuit and generating an output voltage.

2. The resonant converter according to claim 1, wherein the first switch circuit generates an input current according to the input voltage, and the resonant circuit generates a resonant current according to the input current; the primary side of the voltage regulation circuit generates a first voltage according to the resonant current, and the secondary side of the voltage regulation circuit generates a second voltage according to the first voltage; the second switch circuit generates an output current according to the second voltage, and the output circuit generates the output voltage according to the output current.

3. The resonant converter according to claim 2, wherein a current passing through the primary side of the voltage regulation circuit is a first current, and a value of the first current is less than a value of the resonant current.

4. The resonant converter according to claim 1, further comprising a controller electrically connected to the first switch units and the second switch units to provide a plurality of control signals.

5. The resonant converter according to claim 4, wherein each of the first switch units comprises a high-side switch and a low-side switch, and the output node is located between the high-side switch and the low-side switch.

6. The resonant converter according to claim 5, wherein a phase difference between the control signal of the high-side switch and the control signal of the low-side switch is 180 degrees.

7. The resonant converter according to claim 5, wherein there is first deadtime between the control signal of the high-side switch and the control signal of the low-side switch.

8. The resonant converter according to claim 5, wherein the high-side switches comprise a first high-side switch, a second high-side switch, and a third high-side switch, a phase difference between the control signal of the first high-side switch and the control signal of the second high-side switch is 120 degrees, and a phase difference between the control signal of the first high-side switch and the control signal of the third high-side switch is 240 degrees.

9. The resonant converter according to claim 5, wherein each of the second switch units comprises a high-side rectifying switch and a low-side rectifying switch, and the input node is located between the high-side rectifying switch and the low-side rectifying switch.

10. The resonant converter according to claim 9, wherein a phase difference between the control signal of the high-side rectifying switch and the control signal of the low-side rectifying switch is 180 degrees.

11. The resonant converter according to claim 9, wherein there is second deadtime between the control signal of the high-side rectifying switch and the control signal of the low-side rectifying switch.

12. The resonant converter according to claim 9, wherein the high-side rectifying switches comprises a first high-side rectifying switch, a second high-side rectifying switch, and a third high-side rectifying switch, a phase difference between the control signal of the first high-side rectifying switch and the control signal of the second high-side rectifying switch is 120 degrees, and a phase difference between the control signal of the first high-side rectifying switch and the control signal of the third high-side rectifying switch is 240 degrees.

13. The resonant converter according to claim 9, wherein on-time of the control signal of the high-side rectifying switch is less than on-time of the control signal of the high-side switch, and on-time of the control signal of the low-side rectifying switch is less than on-time of the control signal of the low-side switch.

14. The resonant converter according to claim 1, wherein the voltage regulation circuit comprises a plurality of transformers, the primary sides of the transformers are coupled to one another by the delta connection, and the secondary sides of the transformers are coupled to one another by the delta connection.

15. The resonant converter according to claim 14, wherein each of the transformers comprises a primary side coil winding set, a magnetizing inductor, and a secondary side coil winding set; the primary side coil winding set is disposed on the primary side and is coupled to the magnetizing inductor in parallel, and the primary side coil winding sets are coupled to the resonant capacitors by the connection nodes; the secondary side coil winding sets are disposed on the secondary side to be coupled to the input nodes.

16. The resonant converter according to claim 15, wherein each of the transformers comprises a magnetic core, the magnetic cores are independent of one another, and the magnetic core comprises an upper cover, a lower cover, a first edge rod, a second edge rod, and a central rod; the first edge rod, the second edge rod, and the central rod are disposed between the upper cover and the lower cover, and the central rod is disposed between the first edge rod and the second edge rod; the primary side coil winding set and the secondary side coil winding set surround the central rod.

17. The resonant converter according to claim 15, wherein each of the transformers comprises a magnetic core, the magnetic cores are sequentially disposed and share an upper cover and a lower cover, and the magnetic core comprises a first edge rod, a second edge rod, a middle cover plate, and a central rod; the first edge rod, the second edge rod, the central rod are disposed between the upper cover and the lower cover, and the central rod is disposed between the first edge rod and the second edge rod; the primary side coil winding set and the secondary side coil winding set surround the central rod, and the middle cover plate of one of the magnetic cores serves as the lower cover.

18. The resonant converter according to claim 15, wherein the transformers comprise a magnetic core and share the magnetic core, and the magnetic core comprises an upper cover, a lower cover, a first edge rod, a second edge rod, and a plurality of central rods; the first edge rod, the second edge rod, and the central rods are disposed between the upper cover and the lower cover, and the central rods are disposed between the first edge rod and the second edge rod; the primary side coil winding sets and the secondary side coil winding sets surround the central rods.

19. The resonant converter according to claim 18, wherein the central rods are separate from one another.

20. The resonant converter according to claim 18, wherein the central rods are coupled to one another.

21. The resonant converter according to claim 15, wherein the transformers comprise a magnetic core and share the magnetic core, and the magnetic core comprises an upper cover, a lower cover, and a plurality of central rods; the central rods are disposed between the upper cover and the lower cover, and the primary side coil winding sets and the secondary side coil winding sets surround the central rods.

22. The resonant converter according to claim 1, wherein the first switch units comprise a first high-side switch, a first low-side switch, a second high-side switch, a second low-side switch, a third high-side switch, and a third low-side switch, and the second switch units comprise a first high-side rectifying switch, a first low-side rectifying switch, a second high-side rectifying switch, a second low-side rectifying switch, a third high-side rectifying switch, and a third low-side rectifying switch.

23. The resonant converter according to claim 22, wherein the third high-side switch generates an input current according to the input voltage when the first high-side switch is turned off, the first low-side switch is turned on, the second high-side switch is turned off, the second low-side switch is turned on, the third high-side switch is turned on, and the third low-side switch is turned off, and one of the resonant tanks generates a resonant current according to the input current; the primary side of the voltage regulation circuit generates a first voltage according to the resonant current, and the secondary side of the voltage regulation circuit generates a second voltage according to the first voltage; the first high-side rectifying switch is turned off, the first low-side rectifying switch is turned on, the second high-side rectifying switch is turned off, the second low-side rectifying switch is turned on, the third high-side rectifying switch is turned on, and the third low-side rectifying switch is turned off; the third high-side rectifying switch outputs an output current into the output circuit according to the second voltage.

24. The resonant converter according to claim 22, wherein the first high-side switch and the third high-side switch generate two input currents according to the input voltage when the first high-side switch is turned on, the first low-side switch is turned off, the second high-side switch is turned off, the second low-side switch is turned on, the third high-side switch is turned on, and the third low-side switch is turned off, and two of the resonant tanks generate two resonant currents according to the two input currents; the primary side of the voltage regulation circuit generates two first voltages according to the two resonant currents, and the secondary side of the voltage regulation circuit generates two second voltages according to the two first voltages; the first high-side rectifying switch is turned on, the first low-side rectifying switch is turned off, the second high-side rectifying switch is turned off, the second low-side rectifying switch is turned on, the third high-side rectifying switch is turned on, and the third low-side rectifying switch is turned off, the first high-side rectifying switch and the third high-side rectifying switch separately output an output current into the output circuit according to the two second voltages.

25. The resonant converter according to claim 22, wherein the first high-side switch generates an input current according to the input voltage when the first high-side switch is turned on, the first low-side switch is turned off, the second high-side switch is turned off, the second low-side switch is turned on, the third high-side switch is turned off, and the third low-side switch is turned on, and one of the resonant tanks generates a resonant current according to the input current; the primary side of the voltage regulation circuit generates a first voltage according to the resonant current, and the secondary side of the voltage regulation circuit generates a second voltage according to the first voltage; the first high-side rectifying switch is turned on, the first low-side rectifying switch is turned off, the second high-side rectifying switch is turned off, the second low-side rectifying switch is turned on, the third high-side rectifying switch is turned off, and the third low-side rectifying switch is turned on; the first high-side rectifying switch outputs an output current into the output circuit according to the second voltage.

26. The resonant converter according to claim 22, wherein the first high-side switch and the second high-side switch generate two input currents according to the input voltage when the first high-side switch is turned on, the first low-side switch is turned off, the second high-side switch is turned on, the second low-side switch is turned off, the third high-side switch is turned off, and the third low-side switch is turned on, and two of the resonant tanks generate two resonant currents according to the two input currents; the primary side of the voltage regulation circuit generates two first voltages according to the two resonant currents, and the secondary side of the voltage regulation circuit generates two second voltages according to the two first voltages; the first high-side rectifying switch is turned on, the first low-side rectifying switch is turned off, the second high-side rectifying switch is turned on, the second low-side rectifying switch is turned off, the third high-side rectifying switch is turned off, and the third low-side rectifying switch is turned on; the first high-side rectifying switch and the second high-side rectifying switch separately output an output current into the output circuit according to the two second voltages.

27. The resonant converter according to claim 22, wherein the second high-side switch generates an input current according to the input voltage when the first high-side switch is turned off, the first low-side switch is turned on, the second high-side switch is turned on, the second low-side switch is turned off, the third high-side switch is turned off, and the third low-side switch is turned on, and one of the resonant tanks generates a resonant current according to the input current; the primary side of the voltage regulation circuit generates a first voltage according to the resonant current, and the secondary side of the voltage regulation circuit generates a second voltage according to the first voltage; the first high-side rectifying switch is turned off, the first low-side rectifying switch is turned on, the second high-side rectifying switch is turned on, the second low-side rectifying switch is turned off, the third high-side rectifying switch is turned off, and the third low-side rectifying switch is turned on; the second high-side rectifying switch outputs an output current into the output circuit according to the second voltage.

28. The resonant converter according to claim 22, wherein the second high-side switch and the third high-side switch generate two input currents according to the input voltage when the first high-side switch is turned off, the first low-side switch is turned on, the second high-side switch is turned on, the second low-side switch is turned off, the third high-side switch is turned on, and the third low-side switch is turned off, and two of the resonant tanks generate two resonant currents according to the two input currents; the primary side of the voltage regulation circuit generates two first voltages according to the two resonant currents, and the secondary side of the voltage regulation circuit generates two second voltages according to the two first voltages; the first high-side rectifying switch is turned off, the first low-side rectifying switch is turned on, the second high-side rectifying switch is turned on, the second low-side rectifying switch is turned off, the third high-side rectifying switch is turned on, and the third low-side rectifying switch is turned off; the second high-side rectifying switch and the third high-side rectifying switch separately output an output current into the output circuit according to the two second voltages.
